(19) United States
(12) Patent Application Publication
(10) Pub. No.: US 2002/0178110 A1
(43) Pub. Date: Nov. 28, 2002

(54) Information communication apparatus, service providing system, information communication method, information communication program, recording medium storing the information communication program

(76) Inventors: Syoichiro Yoshiura, Ikoma-gun (JP); Kohichi Murakami, Yamatokoriyama-shi (JP); Yasuhiro Nakai, Soraku-gun (JP)

Correspondence Address: NIXON & VANDERHYE P.C., 8th Floor, 1100 North Glebe Road, Arlington, VA, 22201-4714, US

(21) Appl. No.: 10/035,159

(22) Filed: Jan. 4, 2002

(30) Foreign Application Priority Data
May 22, 2001 (JP) 2001-153080

(51) Int. Cl. G06F 17/60

(52) U.S. Cl. 705/37

(57) ABSTRACT

The present invention is to provide an information communication apparatus which can reduce the user's load required in managing a user device (printing machine etc.). In the information communication apparatus, an information generating section selects a required article according to the status of a digital complex machine, and generates purchase information to purchase the article. Further, the purchase information is opened, via an auction server, to plural sales shops (sales terminals), and sales information (price, date for delivery), transmitted from respective sales shops, are obtained by an information transmitting section and an information receiving section. Thus, in the information communication apparatus, it is possible to obtain the sales information of an article required in the digital complex machine, without receiving the user's instruction. Therefore, it is possible to remarkably reduce the user's load required in managing the digital complex machine.

### FIELD OF THE INVENTION

The present invention relates to an information communication apparatus, provided in a user device, which is set to be capable of performing communication with the outside via a network, a service providing system which includes the apparatus, an information communication method used in the apparatus, an information communication program for actuating a computer so as to realize the apparatus and the method thereof, and a recording medium which stores the program.

### BACKGROUND OF THE INVENTION

Conventionally, various business systems using a network (internet, telephone line, etc.) has been proposed in connection with electric products such as a digital copying machine, and a personal computer.

For example, Japanese Unexamined Patent Publication No. 114907/1997 (Tokukaihei 9-114907, corresponding to U.S. Pat. No. 6,078,906) (publication date: May 2, 1997) discloses a system in which document service (fetching images, printing, transmitting process, etc.) can be ordered in accordance with a broker auction which is held by using the network.

Further, Japanese Unexamined Patent Publication No. 340301/1998 (Tokukaihei 10-340301, corresponding to U.S. Pat. No. 6,199,755) (publication date: Dec. 22, 1998) discloses the following system. In a case where an electric product is out of order, trouble information and guarantee information are stored in an IC card so as to transmit the stored information via the network to a service center. Further, the service center provides an estimate in accordance with the transmitted information.

Further, in the system, a repairing cost can be paid based on an electric money settlement by using the IC card.

Incidentally, in a case where a printing apparatus such as the digital copying machine was used continuously, it was required that expendables such as toner and sheet (recording paper) were supplemented suitably, and it was necessary to examine the printing apparatus regularly.

However, the foregoing conventional systems were insufficient to supplement the expendables and perform regular examinations with respect to the printing apparatus.

That is, in the foregoing systems, the order for the document service and the transmission of the guarantee and trouble information were performed in accordance with a direction of a user who managed the printing apparatus.

Thus, in a case where the expendables were supplemented by using the systems, the user had to check how many expendables were left, and had to perform an ordering process by himself/herself when left expendables became few.

Further, as to the regular examinations, it was required that the user judged (checked) a proper timing for the examination and ordered by himself/herself.

In this way, in the conventional systems, it was possible to increase the efficiency in transmitting information, which includes the ordered content, due to the network, but it was required that the user ordered (began to order) by himself/herself. Thus, it was difficult to reduce the user's load required in managing the printing apparatus.

### SUMMARY OF THE INVENTION

The present invention is to solve the foregoing conventional problems. Further, the object thereof is to provide: an information communication apparatus which can reduce the user's load required in managing a user device (printing apparatus etc.); a service providing system which includes the apparatus; an information communication method used in the apparatus; an information communication program for realizing the apparatus and the method thereof by a computer; and a recording medium which stores the program.

In order to achieve the foregoing object, the information communication apparatus of the present invention (present communication apparatus), provided in a user device, which is set to be capable of performing communication with the outside via a network, includes: an information generating section for selecting an article suitable for maintenance of the user device so as to generate purchase information which indicates that purchase of the article is required, in accordance with the status of the user device; and a communication section for opening the purchase information to plural dealers, and for receiving sales information corresponding to sales conditions of the article, from the respective dealers so as to inform the sales information to a user.

According to the foregoing arrangement, it is possible to obtain information of an article (sales information) which is required (useful) in maintenance of the user device at an appropriate timing, without receiving the user's direction. Thus, it is possible to remarkably reduce the user's load required in managing the user device. Further, the user can select the most appropriate condition from plural sales conditions, so as to purchase a maintenance article.

Further, in order to achieve the foregoing object, the information communication method of the present invention (present communication method) for transmitting information of a user device via a network to outside, and for receiving information transmitted from the outside, includes: an information generating process for selecting an article suitable for maintenance of the user device in accordance with status of the user device, and for generating purchase information, which indicates that a purchase of the article is required; and a communication informing process for opening the purchase information to plural dealers, and for receiving sales information, which indicate sales conditions of the article, from respective dealers, so as to inform the sales information to the user.

According to the foregoing method, it is possible to obtain information of an article (sales information) which is required (useful) in maintenance of the user device at an appropriate timing, without receiving the user's instruction. Thus, it is possible to remarkably reduce the user's load required in managing the user device.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a block diagram showing a communication form in an auction system according to the first embodiment of the present invention.

FIG. 2 is an explanatory drawing showing an arrangement of the auction system.

FIG. 3 is an explanatory drawing showing how purchase information is transmitted to an auction server in a case where toner run short in a digital complex machine which belongs to the auction system shown in FIG. 2, and in a case where time for a regular examination comes.

FIG. 4 is a flow chart showing how a left toner confirming process is performed in an information communication apparatus provided in the foregoing digital complex machine.

FIG. 5 is a flow chart showing how a regular examination period confirming process is performed in the information communication apparatus provided in the digital complex machine.

FIG. 6 is a flow chart showing how a reverse auction process is performed in the auction server which belongs to the auction system shown in FIG. 2.

FIG. 7 is an explanatory drawing showing a display example of an auction site which is displayed on a screen of a sales terminal which belongs to the auction system shown in FIG. 2.

FIG. 8 is an explanatory drawing showing a display example (user confirmation screen) of sales information displayed on the screen of the information communication apparatus.

FIG. 9 is a graph showing how a life of a maintenance article is reduced in the digital complex machine.

FIG. 10 is an explanatory drawing showing how purchase information of peripheral devices are transmitted to the auction server in a case where it is beneficial that the peripheral devices (a post-processing device, a mass storage cassette, etc.) are provided in the digital complex machine which belongs to the auction system shown in FIG. 2.

FIG. 11 is a flow chart showing how machine information of the digital complex machine is registered to the auction system shown in FIG. 2.

FIG. 12 is a flow chart showing how the machine information, registered to the auction server shown in FIG. 2, is renewed.

### DESCRIPTION OF THE EMBODIMENT

[first embodiment]

The first embodiment of the present invention is described as follows.

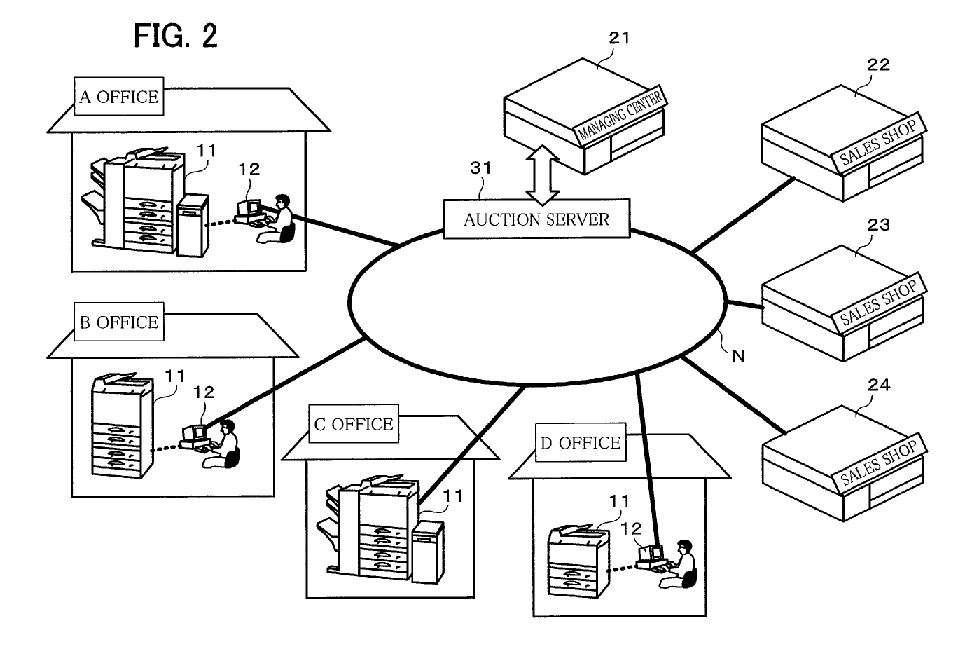

FIG. 2 is an explanatory drawing showing an arrangement of an auction system (present system) according to the present embodiment. The present system includes: A to D offices as users of a digital complex machine 11; a managing center 21 and sales shops 22 to 24; and a network N used to perform communication between them.

The digital complex machine (user device) 11 functions as a copying machine, a printer, and a facsimile, and is sold (or lent) to users such as an office, a shop, and an ordinary family so as to be used there.

The sales shops 22 to 24 are service companies which .specialize in selling a maintenance article and a peripheral device of the digital complex machine 11.

Here, the maintenance article is an article concerning the maintenance of the digital complex machine 11, and is material and service which are required (or useful) in using the digital complex machine 11 continuously and in a good condition. The maintenance article includes, for example, expendables, replacement parts, repairing service with respect to troubles of the digital complex machine 11, and examining service with respect to the digital complex machine 11, and the like.

Note that, the expendables are material which decrease according to use of the digital complex machine 11, and include, for example, toner and sheet (recording paper) etc. Further, the replacement parts are parts which are required to be replaced suitably according to use (part which is likely to deteriorate), and include, for example, a photosensitive drum, a belt and a roller for transporting a manuscript note (or a sheet), a developer (iron powder) in a two-component toner, and the like.

A managing center is an office under control of a manufacturer (maker) of the digital complex machine 11.

Further, in the present system, the user of the digital complex machine 11 selects a service office (sales shop) in which the user purchases the maintenance article, in accordance with a reverse auction organized by the managing center 21.

That is, the present system is a system for deciding a service office which performs the maintenance in accordance with the reverse auction. Note that, the reverse auction is a bid for gathering sales shops (dealers who want to sell articles) in which the user purchases the maintenance article.

Here, a concrete arrangement of the present system is described as follows.

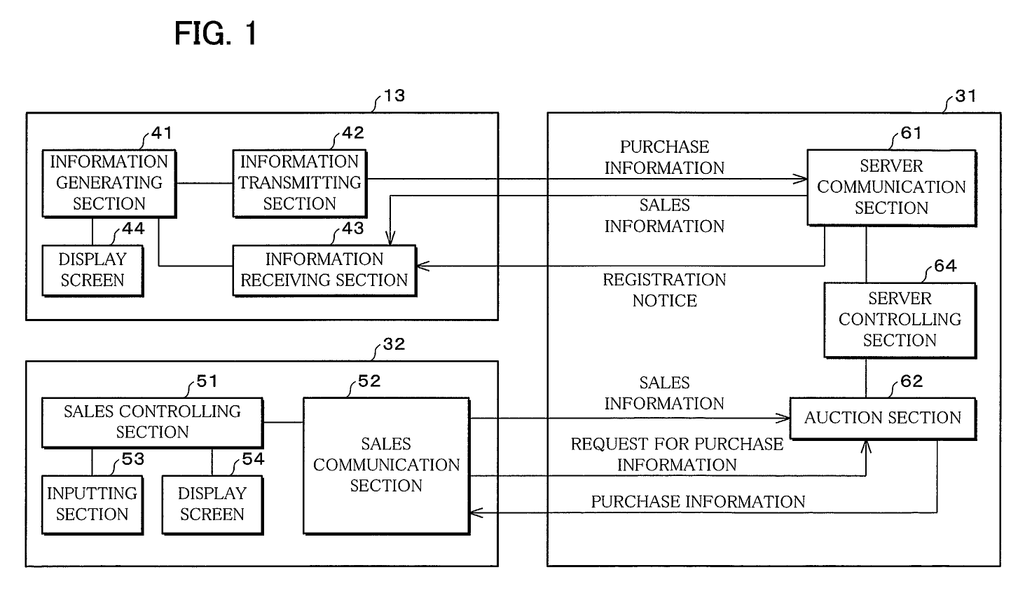

As shown in FIG. 2, a personal computer (PC) is provided in a digital complex machine 11 possessed by each of offices A, B, and D. Further, each PC 12 has an information communication apparatus 13 described later (see FIG. 1) therein. Further, in the office C, the information communication apparatus 13 is provided in the digital complex machine 11.

Further, respective information communication apparatuses 13, as shown in FIG. 2, are connected to a network N.

Further, as shown in FIG. 2, the managing center 21 has an auction server 31 connected to the network N. Further, each of the sales shops 22 to 24 has a sales terminal 32, described later (see FIG. 1), which is connected to the network N.

FIG. 1 is an explanatory drawing showing a communication form of the present system, that is, a communication form build among the information communication apparatus 13, the auction server 31, and the sales terminal 32.

As described above, the information communication apparatus 13, the auction server 31, and the sales terminal 32 are connected via the network N shown in FIG. 2 to each other. Note that, the network N is a line only for the reverse auction, and can be connected by only the person who made registration so as to be a member (a candidate for purchase or a candidate for sale) of the reverse auction.

The information communication apparatus 13 is provided in the digital complex machine 11, and is used to perform communication (reciprocal communication) between the auction server 31 and the sales terminal 32 via the network N. Further, as shown in FIG. 1, the information communication apparatus 13 includes: an information generating section 41; an information transmitting section 42; an information receiving section 43; and a display screen 44.

The information generating section 41 has a memory section (not shown) which records information (name, function, performance, and price etc.) of the maintenance article of the digital complex machine 11. Further, the information generating section 41 is set to select a maintenance article suitable for the maintenance of the digital complex machine 11 from various maintenance articles, in accordance with the status of the digital complex machine 11.

Here, the status of the digital complex machine 11 means whether the digital complex machine 11 is in trouble or not, or means an operating environment, operation log, performance, amount of left expendables, deterioration of replacement parts etc. of the digital complex machine 11.

Further, the information generating section 41 generates purchase information, which indicates that purchase of the selected maintenance article is required.

Further, the information generating section 41 is set so that specifying information is included in the purchase information. The specifying information is information for specifying a purchase condition, and for specifying the digital complex machine 11. For example, the specifying information includes information such as the ceiling of a sales price, the time limit for delivery (or deadline for sales application), a type (model number) of the digital complex machine 11, an installation place (place in which the maintenance article is to be installed: address, name of an institution etc.), an address of the user, and the like.

The information transmitting section (communication section) 42 is to transmit information via the network N to an external device (auction server 31, sales terminal 32). Further, the information transmitting section 42 is set to generate an electric mail (purchase mail) which includes a direction to perform the reverse auction and the sales information, and to transmit the electric mail to the auction server 31 (exhibition of an article in the reverse auction) so as to open the purchase information generated by the information generating section 41 to the respective sales shops 22 to 24.

The information receiving section (communication section) 43 is to receive information transmitted via the network N from the external devices (auction server 31, sales terminal 32). Further, particularly, the information receiving section 43 has functions to receive sales information (described later) of the sales shops 22 to 24 transmitted from the auction server 31, and to display the information on the display screen 44.

The auction server 31 is to perform the reverse auction based on the purchase information (purchase information included in the purchase mail) transmitted from the information communication apparatus 13. That is, the auction server 31 has functions to open the purchase information to the sales shops 22 to 24, and to collect the sales information from the respective sales shops 22 to 24 so as to transmit the information to the information communication apparatus 13. Note that, a concrete arrangement of the auction server 31 is described later.

The sales terminal 32 is a terminal used by each of salesclerks of the sales shops 22 to 24. Further, the purchase information, opened by the auction server 31, are grasped (obtained) regularly so that proper maintenance is performed according to the status of the respective digital complex machines 11 installed in the offices A to D.

As shown in FIG. 1, the purchase terminal 32 includes: a sales controlling section 51; a sales communication section 52; an input section 53; and a display screen 54.

The sales communication section 52 is to transmit and receive information to and from the external devices (auction server 31, information communication apparatus 13) via the network N. The input section 53 is to receive an input direction performed by the salesclerks with respect to the sales terminal 32.

The sales controlling section 51 is to control the purchase communication section 52 so that the purchase communication section 52 obtain the opened purchase information (purchase information transmitted from the auction server 31) regularly, and to make the display screen 54 display the information (request for the purchase information (information indicative of the content of the auction), confirmation of the purchase information).

Further, in the sales terminal 32, the sales condition is inputted to the input section 53 by the salesclerk in a case where the salesclerk wants to sell a maintenance article indicated in the purchase information. In response to this, the sales controlling section 51 generates the sales information indicative of the inputted sales condition, and controls the sales communication section 52 so as to transmit the information to the server 31 (participation in the reverse auction; registration of the sales information).

Here, the sales condition (bid condition) of the maintenance article is the content of the service provided by the sales shops 22 to 24 concerning the article sales, and, for example, is a condition such as the quality, the price, the amount of sales articles, and a delivery period.

Here, an arrangement of the auction server 31 is described as follows.

As shown in FIG. 1, the auction server 31 includes: a server communication section 61; an auction section 61; and a server controlling section 64.

The server communication section 61 is to perform communication with the information communication apparatus 13.

The auction section (open section, collecting section) 62 is to maintain and manage an auction site opened in the network N, and to perform communication with the sales terminals 32 of the sales shops 22 to 24. That is, the auction section 62 is to open the purchase information transmitted from the information communication apparatus 13 to the sales terminals 32 of the sales shops 22 to 24 by using the auction site. Further, the auction section 62 has also a function to collect the sales information transmitted from the sales shops 22 to 24.

The server controlling section 64 is a central portion for controlling entire operations of the reverse auction performed by the auction server 31. That is, the server controlling section 64 extracts the purchase information from the purchase mail, in a case where the purchase mail is transmitted to the server communication section 61. Further, the server controlling section 64 controls the server communication section 61 so that the server communication section 61 transmits a registration notice, which indicates that the reverse auction is performed based on the purchase information included in the purchase mail, to the information communication apparatus 13 which transmitted the purchase mail. Thereafter, the server communication section 61 controls the auction section 62 so that the auction section 62 opens the purchase information in the auction site so as to refer to (obtain) the information by the sales terminals 32.

Further, the server controlling section 64 arranges the sales information collected by the auction section 62, and generates an electric mail (sales mail) which includes the entire sales information. Thereafter, the server controlling section 64 controls the server communication section 61 so that the server communication section 61 transmits the sales mail to the information communication apparatus 13 of the digital complex machine 11.

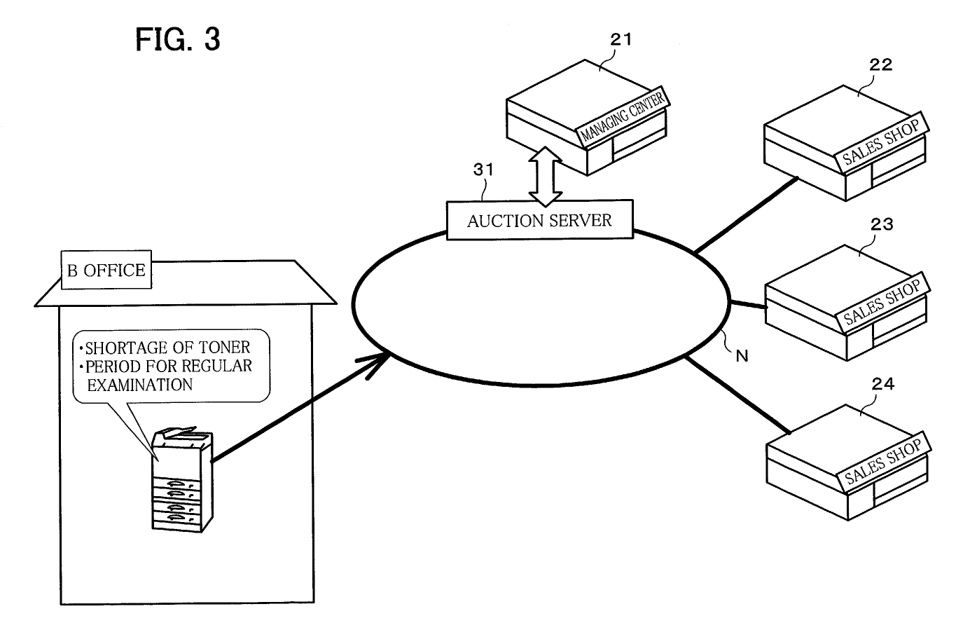

Next, by using a case where toner runs short in the digital complex machine 11 of the office B as shown in FIG. 3, and a case where a time for a regular examination comes as examples, operations (procedure of the reverse auction) of the present system are described as follows.

First, confirmation of the condition (confirmation of the amount of left toner, and confirmation of the regular examination period) performed by the information generating section 41 of the information communication apparatus 13 in the digital complex machine 11 is described as follows. And a process for exhibition (exhibition in the reverse auction) of the maintenance article (toner regular examination) is described as follows.

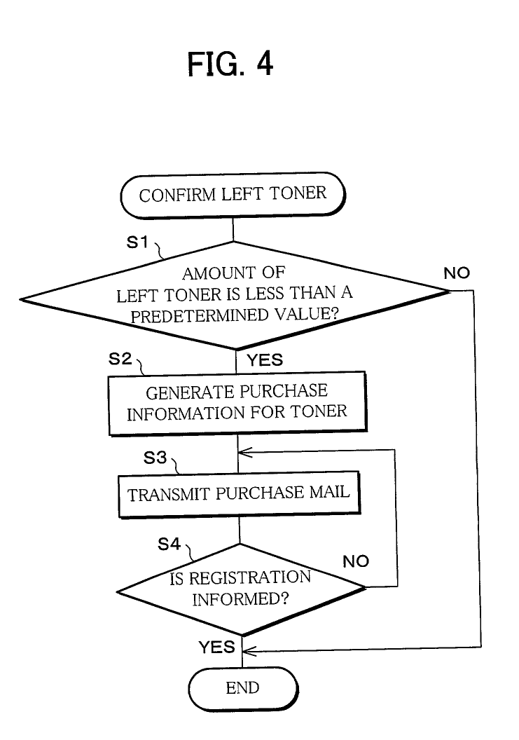

In the digital complex machine 11, the information generating section 41 detects the shortage of toner of the digital complex machine 11 by a process (left toner confirming process) shown in FIG. 4. That is, as shown in FIG. 4, the information generating section 41 makes a detector (not shown), provided on a toner bath (not shown) of the digital complex machine 11, confirm the amount of toner left in the toner bath (S1).

Further, in a case where the amount of the left toner is more than a predetermined value, the information generating section 41 finishes the process.

While, in a case where the amount of the left toner is less than a predetermined value, the information generating section 41 generates the purchase information which indicates that purchase of the toner is required (S2). Note that, the process of S2 is described later more concretely.

Further, the information generating section 41 generates the purchase information, and the purchase mail which includes the specifying information (information for specifying the digital complex machine 11, and information indicative of the sales condition), and controls the information transmitting section 42 so that the information transmitting section 42 transmits the purchase mail to the auction server 31 (S3).

Further, the information generating section 41 judges whether the auction server 31 transmitted the registration notice or not, after a predetermined time has passed (S4). Further, while the process is finished in a case where the registration notice has been transmitted, the step goes back to S3 and retransmission of the purchase mail is performed in a case where the registration notice has not been transmitted.

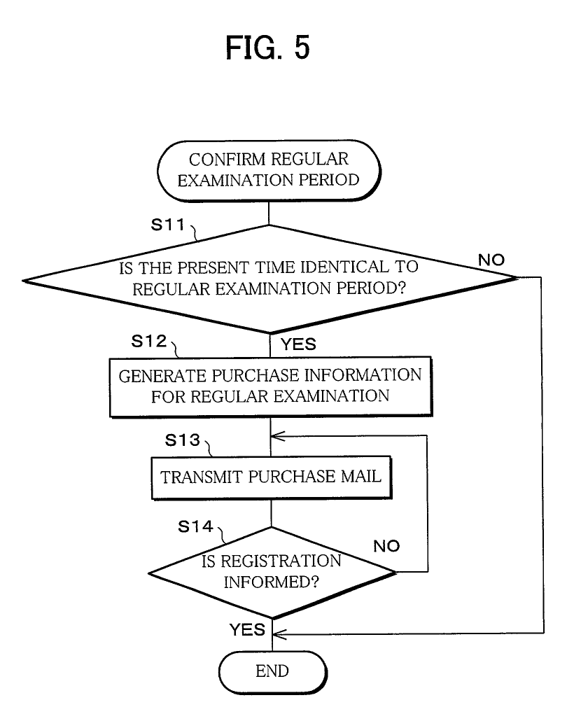

Further, in the digital complex machine 11, the information generating section 41 detects the regular examination period of the digital complex machine 11 by a process (regular examination period confirming process) as shown in FIG. 5. That is, as shown in FIG. 5, the information generating section 41 confirms whether the present time is identical to the regular examination period or not by a timer (not shown) of the digital complex machine 11 (S11).

Further, in a case where the present time is not identical to the regular examination period, the information generating section 41 finishes the process.

While, in a case where the present time is identical to the regular examination period, the information generating section 41 generates the purchase information which indicates the regular examination is required (S12). Further, the information generating section 41 generates the purchase mail which includes the purchase information and the specific information, and controls the information transmitting section 42 so that the information transmitting section 43 transmits the mail to the auction server 31 (S13).

Further, the information generating section 41 judges whether the registration notice is transmitted from the auction server 31 or not after a predetermined time has passed, as in a case of purchasing the toner (S14). Further, while the process is finished in a case where the registration notice has been transmitted, the step goes back to S13 and retransmission of the purchase mail is performed.

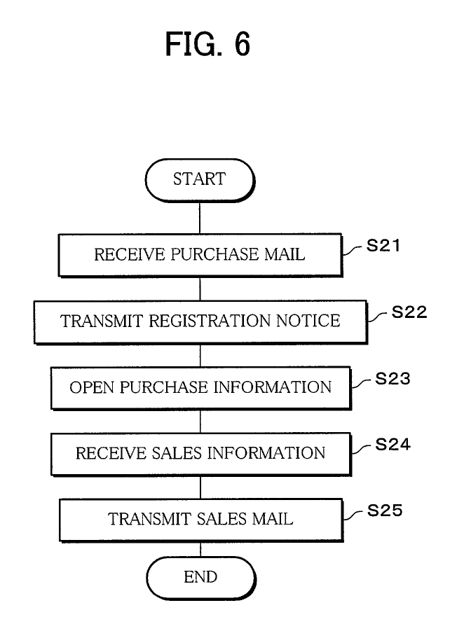

Next, a reverse auction process, performed in the auction server 31 which received the purchase mail, is described as follows. FIG. 6 is a flow chart showing a procedure of the process.

As shown in FIG. 6, in a case where the purchase mail is transmitted to the server communication section 61 (S21), the server controlling section 64 of the auction server 31 extracts the purchase information from the purchase mail. Further, the server communication section 61 is controlled so that the registration notice, which indicates that the reverse auction is performed in accordance with the purchase information, is transmitted to the information communication apparatus 13 which transmitted the purchase mail (S22).

Thereafter, the server communication section 61 controls the auction section 62 so that the auction section 62 opens the purchase information in the auction site so as to obtain the information by the sales terminal 32 (S23).

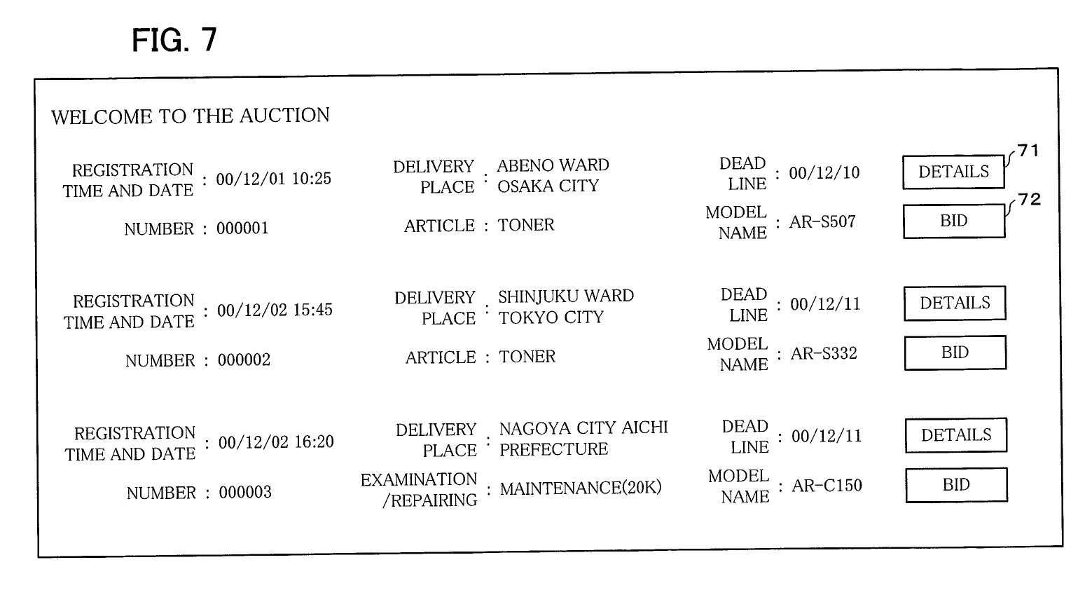

FIG. 7 is an explanatory drawing showing an example of how the auction site is displayed on the display screen 54 of the sales terminal 32. As shown in FIG. 7, purchase information, transmitted from the plural digital complex machines 11 (information communication apparatus 13) registered in the present system, are written in the auction site.

Further, in the example shown in FIG. 7, a desired maintenance article (exhibited article: “toner” “examination/repairing service; maintenance (20K)”), specifying information (delivery place, deadline, model name of the digital complex machine 11), and the like, are displayed as the purchase information.

Further, a details button 71 and a bid button 72 are set in each purchase information. The buttons 71 and 72 are set so that they can be selected on the display screen 54, and the respective buttons are used to open more concrete purchase information, and give direction to participate in the auction.

That is, a salesclerk in each of the sales shops 22 to 24, who referred to the auction site, selects the bid button 72 by using a mouse etc., in a case where he/she wants to participate in the reverse auction. Further, the sales condition is inputted by using a bid image (not shown) displayed later.

In response to this, the sales controlling section 51 of the sales terminal 32 generates the sales information which indicates the sales condition that has been inputted, and transmits the information via the sales communication section 52 to the auction section 62. When the sales information are collected in the auction section 62 (FIG. 6; S24) in this way, the server controlling section 64 arranges the collected sales information so as to generate the sales mail. Further, the server communication section 61 is controlled so that the server communication section 61 transmits the mail to the information communication apparatus 13 of the digital complex machine 11 (S25), and the process is finished.

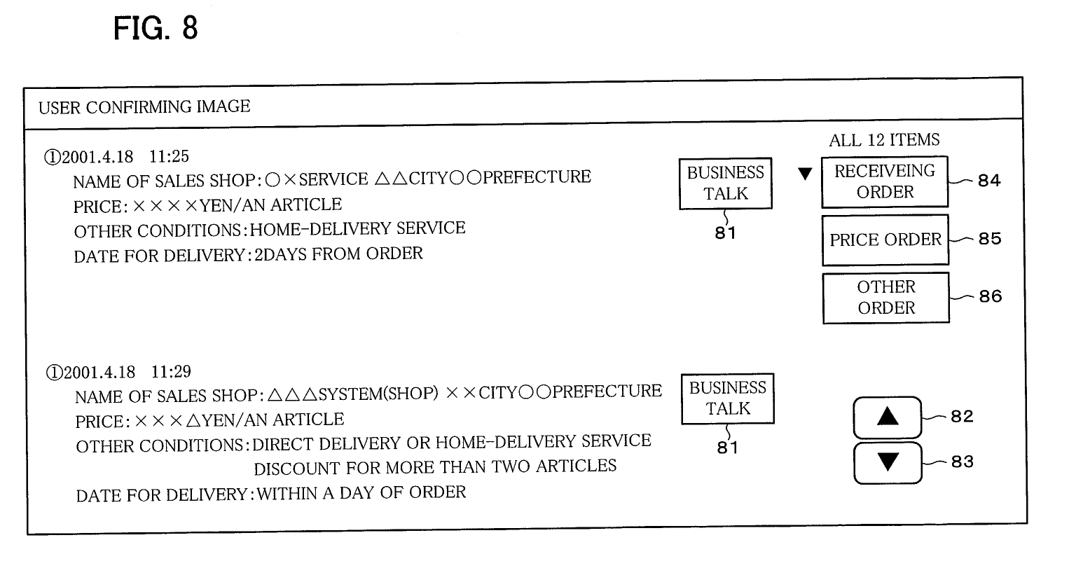

In response to this, in the information communication apparatus 13, the information receiving section 43 receives the sales mail which includes the sales information, and the display screen 44 is made to display the sales mail. FIG. 8 is an explanatory drawing showing an example of how the sales information is displayed (user confirming image) on the display screen 44.

As shown in FIG. 8, in the sales mail transmitted from the auction server 31, all the sales information, provided with respect to the purchase information, are written. Further, such numerals as \mathring{1}, \mathring{2}, . . . are given to the respective sales information.

In the example shown in FIG. 8, as the sales information, the sales condition such as information (name and address of a shop) which specifies a sender (sales shops 22 to 24) of the sales information, price, kinds of delivery, and a date for delivery are displayed.

Further, in this example of display, a business talk button 81 is set in each of the sales information. The business talk button 81 is set so that it can be selected on the display screen 44, and is used to direct that more concrete purchase information (e.g. how to contact the sales shop) be opened.

Further, in this example, the display screen displays: scroll buttons 82 and 83 by which the screen is scrolled so as to display other purchase information; a receiving order button 84 by which order of the purchase information is arranged to be receiving order; a price order button 85 by which the order of the purchase information is arranged to be price order; and an other order button 86 by which the order of the purchase information is arranged to be order setted by the user in his/her own way.

Further, the user of the digital complex machine 11 considers the sales condition with respect to the purchase information so as to select a sales shop in which the user is to purchase a maintenance article, and directly asks the selected sales shop for the maintenance article.

As described above, in the information communication apparatus 13, the information generating section 41 is set to select a maintenance article which is required (or useful) according to the condition of the digital complex machine 11, and to generate purchase information to purchase the maintenance article. Further, the information transmitting section 42 opens the purchase information via the auction server 31 to plural sales shops 22 to 24, and the information receiving section 43 obtains the purchase information, provided by respective sales shops, via the auction server 31 so as to display (transmit) the information to the user. Thus, in the information communication server 13, it is possible to obtain the purchase information of an article which is required (or useful) for maintenance of the digital complex machine 11 at an appropriate timing, without a direction of the user. Therefore, it is possible to remarkably reduce the user's load required in managing the digital complex machine 11.

Further, in the information communication apparatus 13, the information transmitting section 42 and the information receiving section 43 open the purchase information to the plural sales shops 22 to 24, so as to obtain and display the sales information based on the sales condition of the sales shops 22 to 24. Thus, the user can select the most appropriate condition from the plural purchase conditions so as to purchase the maintenance article.

Further, in the present system, the purchase information is opened and the sales information is obtained by using the reverse auction. Thus, as long as the purchase information is transmitted to the auction server 31, the purchase information can be transmitted to the plural sales shops 22 to 24 at once. Thus, compared with a case where the purchase information are transmitted to the sales shops 22 to 24 individually, it is possible to save the trouble required in the communication process. Further, it is possible to easily select a sales shop whose sales condition is most appropriate.

Further, in the information communication apparatus 13, the information generating section 41 is set so that specifying information which specifies the digital complex machine 11 is included in the purchase information. Thus, the salesclerk of each of the sales shops 22 to 24 can judge whether the location of the digital complex machine 11 is within his/her sales area or not, or whether he/she deals in a maintenance article which can be applied to the digital complex machine 11. Therefore, it becomes easier to generate the sales information, so that the user (information communication apparatus 13) of the digital complex machine 11 can receive the sales information quickly and appropriately.

Further, in the present system, the auction server 31 is provided in a managing center 21, an office managed by a maker of the digital complex machine 11, and the managing center organizes the reverse auction. Thus, the maker can grasp a circulation of a maintenance article which is required (or useful) in the digital complex machine 11 in accordance with articles exhibited in the reverse auction. Thus, it is possible to perform the market quality control and the market supply predict appropriately, so that the maker can improve the efficiency in producing the digital complex machine 11 (and its maintenance articles), and can improve a using environment of the digital complex machine 11.

Further, in order to grasp the circulation of the maintenance articles better, the auction section 62 of the auction server 31 may transmit the purchase information (and the sales information) to the maker directly.

Note that, in the present embodiment, the server controlling section 64 of the auction server 31 transmits all the sales information collected in the auction section 62 to the information communication apparatus 13.

However, the arrangement is not restricted to this, but it is preferable that the server controlling section 64 is set to prevent “the sales information indicative of the sales condition which does not satisfy a predetermined standard value” from being transmitted to the auction server 31. Thus, it is possible to prevent inappropriate sales information from being transmitted.

Further, the foregoing standard value is a value which the sales shops participating in the reverse auction must obey. For example, the standard value is set in accordance with a condition for purchase (price, date for delivery etc.), which is included in the specifying information of the purchase information and is set by the user.

Further, the inappropriate information is, for example, sales information which does not correspond to the target maintenance article, and sales information for providing a maintenance article whose quality is inferior.

Further, also there is a case where no sales information, indicative of the sales condition which satisfies the standard value, is collected, due to the difference of areas (distance) between a place where the digital complex machines 11 are provided (offices A to D) and the sales shops 22 to 24, time and date, the shortage of stocks, and the like.

In this case, it is preferable that the server 64 is set so that “a direction to provide the maintenance article to the user of the digital complex machine 11” is informed to a specific wholesale shop of the maintenance article according to the purchase information.

Here, the specific wholesale shop (specific provider) is a dealer who is likely to provide (store) the maintenance article, for example, a maker of the digital complex machine 11 and its maintenance articles, and a wholesale shop (direct sales shop) directly managed by the maker. Thus, it is possible to provide desired maintenance articles without fail, so that it is possible to avoid a state in which the digital complex machine 11 cannot be used due to the shortage of expendables etc.

Note that, in the present system, the managing center 21 is managed by the maker of the digital complex machine 11, so that it is possible to easily give the direction, described above, to the specific wholesale shop.

Further, here, the process shown as S2 in FIG. 4, that is, how the information generating section 41 of the information communication apparatus 13 generates the purchase information of the expendables and replacement parts (toner in FIG. 4) is described.

The information generating section 41 is set to judge when the life of the maintenance article (expendables, replacement parts) will end (time (time and date) when the expendables will run out, or time (time and date) when the replacement parts will deteriorate to such extent that the replacement parts cannot be used), in accordance with how much the life of the maintenance article decreases (extent of decrease).

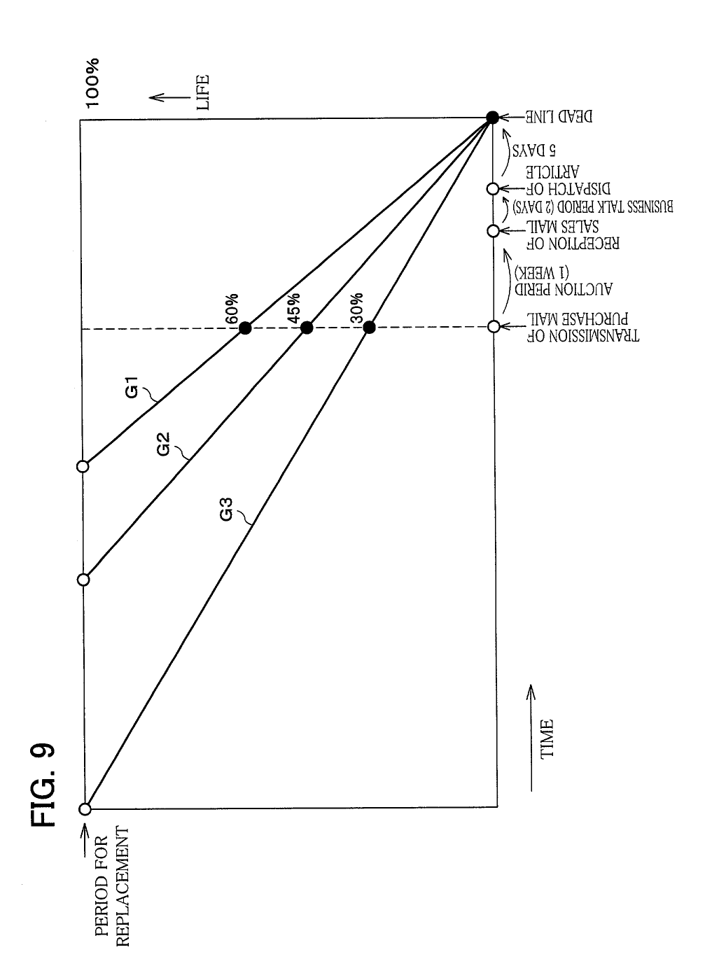

FIG. 9 is a graph showing how the life of the maintenance article decreases. The life of the maintenance article varies according to the frequency in use of the digital complex machine 11 (for example, life of the toner varies from about one month to two months according to the frequency in use). That is, as shown in FIG. 9, in a case where the frequency in use (for example, “frequency of printing/a day” is large, the life of the maintenance article decreases rapidly as shown by a straight line G1. While, in a case where the frequency in use is small, the life decreases slowly as shown by a straight line G2 or a straight line G3.

Further, in a case where the maintenance article is purchased in the present system, it takes some time to receive the delivery of the maintenance article actually since the purchase mail was transmitted (time required to the foregoing procedure is called “purchase time”).

For example, as shown in FIG. 9, in a case where it takes one week to receive the sales mail since the purchase mail was transmitted, and thereafter, it takes two days to select a shop and perform a business talk, and it takes five days to deliver the article. As a result, the purchase time is two weeks.

Here, the information generating section 41 regularly measures the decrease of the life of the maintenance article (slopes of the straight lines G1 to G3 shown in FIG. 9), so as to presume the time when the life will end (learning function).

Further, the information generating section 41 presumes the end of the life (left amount etc.) of the maintenance article in a time calculated by subtracting the purchase time from the presumed time. Further, the information generating section 41 sets the presumed life as a “predetermined value” shown in S2. Note that, the “predetermined value” of the example of FIG. 9 is 60% in a case of the straight line G1, 45% in a case of G2, and 30% in a case of G3.

When the life of the maintenance article ends, the digital complex machine 11 can receive a delivery of a new maintenance article by the foregoing process. Thus, it is possible to avoid a state in which printing cannot be performed due to the shortage of stocks of expendables, or a state in which the quality of a printed image deteriorates since an examination has not been performed for a long time. That is, it is possible to always operate the digital complex machine 11 appropriately.

Note that, in the information communication apparatus 13, it is preferable that the information generating section 41 is set to stop generating the purchase information in a case where the information communication apparatus 13 is directed to stop purchasing by the user. When the information generating section 41 is set in this way, it is possible to avoid executing an unnecessary communication process in a case where a new maintenance article is not required, for example, in a case where the use of the digital complex machine 11 is to be stopped since the digital complex machine 11 is to be scrapped or resold.

[second embodiment]

The second embodiment of the present invention is described as follows. Note that, the same numerals are given to members having the same functions as the members shown in the first embodiment, and descriptions thereof are omitted.

In the first embodiment, there is a description of the case where the expendables, the replacement parts, and the maintenance article such as the regular examination are purchased in the present system shown in FIG. 1. In the present embodiment, there is a description of a case where a peripheral device of the digital complex machine 11 is purchased in the present system.

Here, the peripheral device is an option device for realizing system up of the digital complex machine 11, and includes, for example, a post-processing device such as a sorter and a stapler, a mass storage sheet feeding cassette, an ADF (automatic document feeder) and the like.

That is, in the arrangement, the information generating section 41 of the information communication apparatus 13 is set to select a peripheral device, which is preferable to be provided in the digital complex machine 11, from various peripheral devices, according to the status of the digital complex machine 11 (kinds of peripheral devices which has been provided, operation log, performance (whether a peripheral device can be provided or not) etc.), and is set to generate purchase information to purchase the device.

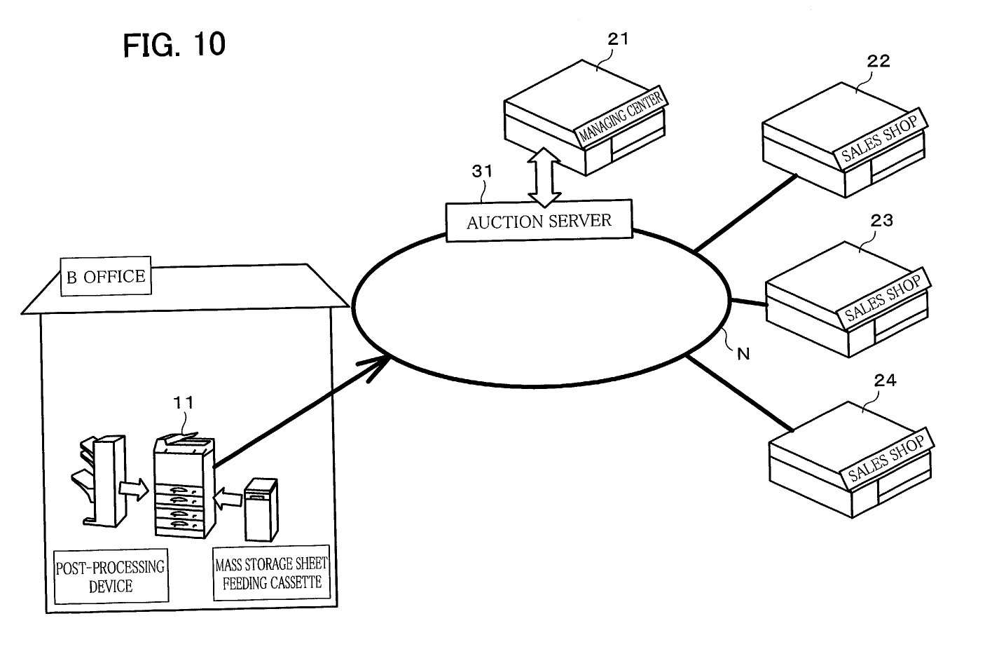

Further, as in the case where the maintenance article is purchased, as shown in FIG. 10, the purchase information is opened to the sales shops 22 to 24 by the reverse auction performed by the auction server 31 (managing center 21), and thereafter, the sales information which includes a sales condition is obtained from the sales shops 22 to 24. Note that, FIG. 10 shows an example in which purchase information concerning a post-processing device and a mass storage sheet feeding cassette is transmitted from the information communication apparatus 13 of the digital complex machine 11, having an ADF, which is installed in the office B.

According to the arrangement, the information generating section 41 includes: a memory section (not shown) in which information (name, function, performance, price etc.) of the peripheral device is stored; and a memory section (not shown) in which operation log (how the digital complex machine 11 has been operated) of the digital complex machine 11 is stored.

Further, a function used so frequently in the digital complex machine 11 is picked up, and a peripheral device for heightening the function is selected as a peripheral device suitable for the digital complex machine 11 (suitable device).

For example, in a case where the digital complex machine 11 has no ADF, and a document cover of a scanner is opened and closed frequently, the information generating section 41 selects an ADF for transporting documents to the scanner as a suitable device.

Further, in a case where a single kind of sheet is used so frequently (in a case where a cassette, in which the sheets are stored, becomes empty so frequently), the information generating section 41 judges a mass storage sheet feeding cassette to be a suitable device. Further, in a case where a sorter having no stapler is provided, and the sorter is used so frequently, the information generating section 41 is set to regard a sorter having a stapler as a suitable device.

Further, after selecting a suitable device in this way, the information generating section 41 generates the purchase information and the purchase mail for purchasing the device so as to make the transmitting section 42 transmit the mail to the auction server 31.

Further, in a case where the auction server 31 receives such purchase mail, the auction server 31 performs the reverse auction as in the process shown in the first embodiment so as to collect information. Further, the auction server 31 is set to generate the sales mail so as to transmit the mail to the information communication apparatus 13.

Further, when the user of the digital complex machine 11 purchases a peripheral device based on the purchase information (realizes system up), the user performs business talk (explanation etc. of the peripheral device) with a sales shop as in the purchase of the maintenance article. In this way, when the peripheral device is purchased by using the information communication apparatus 13, it becomes easier to plan (consider) the system up of the digital complex machine 11.

Further, even though the user does not have sufficient knowledge of the system up of the digital complex machine 11, it is possible to know a device required in the system up.

Further, also on the side of the sales shops 22 to 24, it is possible to promote the sales of the peripheral devices, and it becomes easier to keep the communication with the user of the digital complex machine 11.

Note that, in the present embodiment, in a case of purchasing the peripheral device, the information generating section 41 determines a suitable device in accordance with the using log of the digital complex machine 11. However, the arrangement is not restricted to this, but this may be arranged so that purchase information of peripheral devices which were not purchased (proposal of the system up) are received regularly after the digital complex machine 11 was purchased.

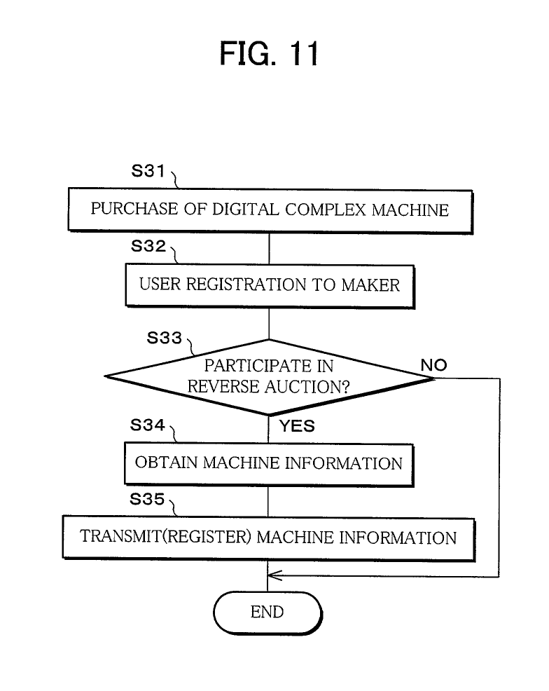

That is, as shown in FIG. 11, when the user purchases the digital complex machine 11, it is usual that the user makes registration which indicates that the user is a user of the digital complex machine 11, with respect to a maker of the digital complex machine 11 (S31, S32) . Further, in this time, according to the foregoing arrangement, the user states whether the user will participate in the reverse auction concerning peripheral devices, with respect to the auction server 31 (managing center 21) (S33).

Further, in a case where the user states that the user participates in the reverse auction, the information generating section 41 obtains information (machine information) of the peripheral device provided in the digital complex machine 11, and transmits and registers the information with respect to the auction server 31 (S34, S35). Thus, the auction server 31 displays the machine information in the auction site. Further, sales information of the peripheral device, which is not provided in the digital complex machine 11, are collected regularly, and the collected information are transmitted to the information communication apparatus 13 from the sales shops 22 to 24 at once.

Note that, in a case where the proposal of the system up is not required, the user does not have to apply for the reverse auction.

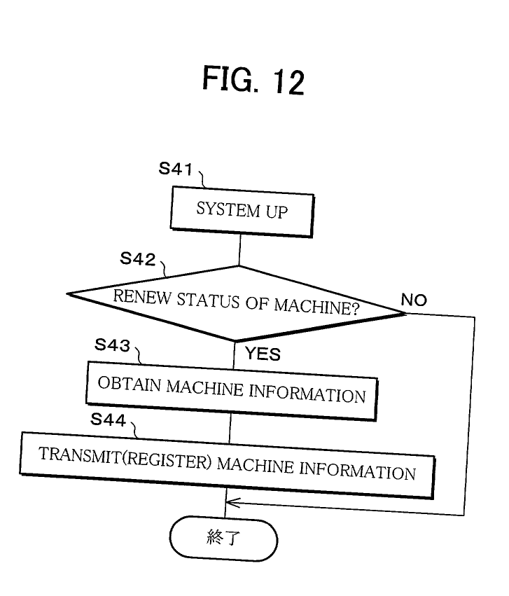

Further, according to the arrangement, in a case where the user purchases the peripheral device so as to perform the system up, as shown in FIG. 12, it is preferable that the machine information registered in the auction server 31 is renewed.

That is, as shown in FIG. 12, after performing the system up (S41), the user judges whether the machine information registered in the auction server 31 is renewed or not, and inputs the judging result to the information communication apparatus 13 (S42). Further, in a case where a direction to change is inputted, the information generating section 41 obtains (re-obtains) the machine information, and transmits and registers (re-registers) the information with respect to the auction server 31 (S43, S44). Thus, it is possible to realize more effective system up.

Further, in this case, it is preferable that the sales shops 22 to 24 compare the machine information registered in the auction server with the machine information renewed after performing the system up, so as to provide a peripheral device which is effective for the system up.

Further, in the process shown in FIG. 12, after performing the system up, the user judges whether the machine information registered in the auction server 31 is renewed or not, and inputs the judging result to the information communication apparatus 13. However, the arrangement is not restricted to this, but the information generating section 41 may be set to obtain the machine information of the digital complex machine 11 regularly, and to renew the machine information registered in the auction server 31 in the case where the machine information is to be changed.

Further, the information communication apparatus 13 obtains sales information of a maintenance article and a peripheral device, and an apparatus (usable apparatus), used as the information communication apparatus 13, is the digital complex machine 11, in the first and second embodiments. However, the information communication apparatus 13 is not restricted to the digital complex machine 11, but it is possible to use various apparatuses used (managed) by the user as the usable apparatus.

The usable apparatus (and main maintenance articles to be purchased) used as the information communication apparatus 13 includes, for example, a monitor, a telephone, a personal computer, a copying machine, a printer, an OA device such as a facsimile (repairing, supplement of developer (toner etc.) and sheet), an automobile (oil, brake pad, clutch plate, tire, replacement of a buttery, regular examination and safety inspection), a vending machine (repairing, article, supplement of changes), an elevator and an escalator (regular examination), an air cleaner and an air conditioner (filter cleaning, replacement of cooling gas), an electric oven, a refrigerator, a washing machine, a drier, an electric product such as a cleaner (repairing), a bomb gas providing system (system in which fuel gas (propane gas etc.) is filled in a bomb so as to provide the bomb to each consumer; replacement of the bomb), and the like.

Particularly, in a case where an automobile is set as the usable apparatus (user device), the information generating section 41 is set to select the required maintenance article and peripheral device in accordance with the status of the automobile (travel distance, travel time etc.).

Further, in a case where an information transmitting section 42 and an information receiving section 43 are installed in the automobile, it is preferable that the information transmitting section 42 transmits the purchase mail and the information receiving section 43 receives the sales mail by radio telephone communication. Further, they may be set to transmit the purchase mail and to receive the sales mail via a terminal provided in a place in which the automobile stops, for example, a car shop, a service area of a highway, a gas station, and the like. In this case, the automobile stops in the vicinity of receiving device (coil etc.) of the terminal, and the automobile passes by the receiving device, so that it is possible to perform transmission and reception of information between the information transmitting section 42/the information receiving section 43 and the terminal.

Further, in the present system, the network N is a line only for the reverse auction, and can be connected by only the user who made registration for participating in the reverse auction. However, the arrangement is not restricted to this, but a general public line (Internet etc.), which can be connected by unspecified users, may be used as the network N.

In this case, the user of the digital complex machine 11 and a sales shop of the maintenance article (peripheral device) can participate in the reverse auction without making the foregoing registration.

Further, any line, which can be connected to the information communication apparatus 13, the auction server 31, and the sales terminal 32, may be used as the network N. For example, not only a wired line but also non-wired line may be used as the network N. Further, as the network N, it is also possible to use a wide area network such as a LAN, and the Internet, and a serial cable connecting apparatuses, and an infrared communication line.

Further, the network N may be built by forming a CUG (Closed User Group) made up of the information communication apparatus 13, the auction server 31, and the sales terminal 32, and by using a public network like a special network.

Further, in the present system, the information generating section 41 includes a memory section for storing information concerning the maintenance article and the peripheral device of the digital complex machine 11. However, the arrangement is not restricted to this, but the information generating section 41 (and the information transmitting section 42/the information receiving section 43) may be set to obtain information (including information of new products) of the maintenance article and the peripheral device from the outside (auction server 31, sales terminal 32 etc.) regularly. By setting in this way, the information generating section 41 can take an updated maintenance article into consideration in selecting the maintenance article.

Further, in the present system, the managing center 21 which organizes the reverse auction is the digital complex machine 11 under the control of an office. However, the arrangement is not restricted to this, but anyone may be the organizer of the reverse auction, as long as he/she can open the auction site (for example, a maker of the maintenance article, an organizer of a retrieving site, and a provider etc. may be the organizer of the reverse auction).

Whoever the organizer may be, it is preferable that an opening section of the auction server 31 is set to transmit the purchase information, transmitted from the information communication apparatus 13, and the sales information, transmitted from the sales shop, to the maker of the digital complex machine 11 (or a maker of the maintenance article) . Thus, the maker can grasp a circulation of the maintenance articles.

Further, in the present invention, the information transmitting section 42 of the information communication apparatus 13 transmits the purchase information (purchase mail) to the auction server 31, so that the purchase information is opened to the sales shops 22 to 24 indirectly. Further, the information receiving section 43 is set to receive the sales information (sales mail) of the sales shops 22 to 24 which were arranged by the auction server 31.

However, the arrangement is not restricted to this, but the information transmitting section 42 may be set to transmit (open) the purchase information directly to the sales shops 22 to 24 not via the auction server 31. Further, the information receiving section 43 may directly obtain (receive) the sales information of the sales shops 22 to 24 not via the auction server 31.

Further, in the present system, the information generating section 41 makes the specifying information included in the purchase information. However, the arrangement is not restricted to this, but the information generating section 41 may include only the information of the maintenance article (or the peripheral device), which is required to be purchased, as the purchase information.

Further, in the present system, the information receiving section 43 displays the sales mail, transmitted to the information communication apparatus 13, on the display screen 44. However, the arrangement is not restricted to this, but the information receiving section 43 may print out the sales mail by the digital complex machine 11.

Further, in the present system, it is preferable that the information generating section 41 performs the left toner confirming process shown in FIG. 4, in a case where the information generating section 41 judges that the toner in the toner bath reduced to some extent. Thus, it is preferable that the information generating section 41 always (regularly) grasps the amount of the toner, left in the toner bath, roughly.

Further, in the present system, the information generating section 41 of the information communication apparatus 13 considers the life of the maintenance article and the purchase time so as to determine the predetermined value shown in S2 of FIG. 4. However, the arrangement is not restricted to this, but the predetermined value may be capable of being set by the user of the digital complex machine 11 in an arbitrary way.

Further, in the present system, the auction server 31 transmits the sales information, transmitted from the sales terminal 32, to the information communication apparatus 13. However, the arrangement is not restricted to this, but the auction server 31 may be set to determine the sales shop (shop in which the maintenance article and the peripheral device are purchased) as a successful bidder in accordance with the sales information (sales condition) transmitted from the respective sales shops.

In this case, it is preferable that the auction server 31 is set to transmit only the information of the sales shop (sales information), determined as the successful bidder, to the information receiving section 43 of the information communication apparatus 13.

Further, in this case, it is preferable that the information generating section 41 of the information communication apparatus 13 makes information, that causes a dealer to be determined as a successful bidder, included in the purchase information. Here, the information, that causes a dealer to be determined as a successful bidder, is information which should be noted in the sales information (quality (types) of the maintenance article and the peripheral device (article), price, date for delivery, and the like).

In this way, according to the information that causes a dealer to be determined as a successful bidder, the auction server 31 (server controlling section 64), for example, regards a sales shop which presents the most reasonable price, or a sales shop which presents the earliest date for delivery, as a successful bidder.

Further, the server controlling section 64 may be set to determine a sales shop as a successful bidder in accordance with the sales information transmitted from the respective sales shops, and may be set to inform the determined successful bidder to the communication section of the information communication apparatus. Thus, it is possible to perform the reverse auction and to determine the successful bidder easily, in accordance with the purchase information and the sales information, by the auction server 31.

Further, in the system, it is preferable that the server controlling section 64 of the auction server 31 is set to prevent “a sales shop, which transmitted sales information indicative of a sales condition which does not satisfy a predetermined standard value, from being determined as a successful bidder”. Thus, it is possible to prevent an inappropriate sales shop from being a successful bidder.

Here, the predetermined standard value is a standard which should be obeyed by sales shops participating in the reverse auction, and for example, is set in accordance with a condition to purchase (price, date for delivery) etc., included in the specifying information of the purchase information, which has been set by the user. Further, the inappropriate sales information is, for example, sales information which targets a wrong article, or sales information which is to provide an inferior article, and the like.

Further, it is preferable that the server controlling section 64 of the auction server 31 is set to inform a specific wholesale shop, which has an article corresponding to the purchase information (see the first embodiment), of “direction to provide the article to the user of the digital complex machine 11”, in a case where there is no sales shop which transmitted the sales information indicative of the sales condition which satisfies the standard value.

Here, the specific wholesale shop (specific wholesale provider) is a dealer, who is so likely to be capable of providing (storing) the article, for example, a maker of the digital complex machine 11 or the article, or a sales shop (direct sales shop) managed directly by the wholesale shop. Thus, it is possible to provide a desired article to the user of the digital complex machine 11 without fail.

Further, in this case, it is preferable that the auction server 31 is managed by the maker of the digital complex machine 11 (or article)(the maker organizes the auction). In this case, it is possible to give the foregoing direction easily to a specific wholesale shop.

Further, it is preferable that the auction server 31 is set to forbid a sales shop, which does not provide appropriate articles (sales shop having no credit), that the sales shop should participate in the reverse auction. Thus, it is possible to restrict a circulation of inappropriate articles.

Further, in the present system, the network N is connected to the sales shops 22 to 24 which are service companies specialized to sell the maintenance articles of the digital complex machine 11. However, the sales shops 22 to 24 need not be the special service company, as long as they are dealers of the maintenance articles, that is, as long as they are corporations or shops (or individuals) in which the maintenance articles are dealt in (sold).

Further, in the present system, the sales controlling section 51 of the sales terminal 32 controls the sales communication section 52 so as to obtain the purchase information, opened in the auction site, regularly. However, the arrangement is not restricted to this, but the sales controlling section 51 may be set to obtain the purchase information as occasion arises, according to a direction of the salesclerks of the sales shops 22 to 24.

Further, when the purchase information is transmitted to the server communication section 61, the auction section 62 of the auction server 31 may be set to open the purchase information in the auction site, and to transmit the information directly (voluntarily) to the sales terminals 32 of the sales shops 22 to 24.

By setting in this way, the sales terminal 32 refers to (obtains) the purchase information, so that it is not required to read the auction site regularly or as occasion arises. Thus, it becomes easier to participate in the reverse auction.

Further, in the first and second embodiments, the information generating section 41, the information transmitting section 42, and the information receiving section 43 perform the generating/transmitting process of the purchase information and the receiving/displaying process (purchase process) of the sales information in the information communication apparatus 13. Further, the server communication section 61, the auction section 62, and the server controlling section 64 perform the reverse auction process in the auction server 31.

However, the arrangement is not restricted to this, but an information processing apparatus, which can store a program for performing the purchase process and the reverse auction process in a recording medium and can read the program, may be used instead of the information generating section 41, the information transmitting section 42, the information receiving section 43, the server communication section 61, the auction section 62, and the server section 64.

According to the arrangement, a calculation device (CPU and MPU) of the information processing apparatus reads the program stored in the recording medium, and executes the purchase process/the reverse process. Thus, it can be said that the program itself executes these processes.

Here, in addition to a general computer (a work station, and a personal computer), a computer for a game, a function expanding board and a function expanding unit, which are installed in the computer, can be used as the information processing apparatus.

Further, the foregoing program is a soft program code of a software which realizes the purchase process/the reverse auction process (execute form program, intermediate code program, source program etc.) The program may be a program which is used as a single program, or may be a program which is used in combination with other programs (OS etc.). Further, the program may be a program used in the following way. After the program is read from the recording medium, the program is stored in a memory (RAM etc.) of the apparatus for a while, and thereafter, the program is read again and is executed.

Further, the recording medium, which stores the program, may be a recording medium which can be detached from the information processing apparatus easily, or may be a recording medium which is fixed (mounted) in the apparatus. Further, the recording medium may be a recording medium which is connected to the apparatus as an external memory.

As the recording medium, a magnetic tape such as a video tape and a cassette tape, a magnetic disc such as a floppy disc and a hard disc, an optical disc (magneto optical disc) such as a CD-ROM, an MO, an MD, a DVD, and a CD-R, a memory card such as an IC card and an optical card, a semiconductor memory such as a mask ROM, an EPROM, an EEPROM, and a flash ROM can be applied.

Further, a recording medium, connected via a network (Intranet, Internet etc.) to the information processing a apparatus, may be used. In this case, the information processing apparatus obtains a program by downloading via the network. That is, the program may be obtained via a transmitting medium (medium which stores a program fluidly) such as a network (connected to a wired line or a non-wired line). Note that, it is preferable that a program, which is to be downloaded, is stored in the apparatus in advance.

Further, the arrangement can be described as follows. A user device of the present invention is arranged so that device information of the user device is opened, so as to obtain information with respect to the opened device information, which is transmitted from plural outside dealers. Further, it is preferable that the arrangement is set so that the device information is exhibited in an auction in which the plural dealers compete with each other, and a result of the auction is informed to the user.

Further, the information communication apparatus of the present invention also can be described as follows. An information communication apparatus, provided in a user device, which is set to be capable of performing communication with the outside via a network, includes: an information generating section for generating device information concerning the user device; a communication section for transmitting the device information to plural sending ends, and for receiving reply information with respect to the device information; and a display section for displaying the reply information. Further, it is preferable that the arrangement is set so that the information generating section generates purchase application information (purchase information), which indicates that purchase of an article concerning the user device is required, as the device information. And it is preferable that the arrangement is set so that the communication section opens the purchase application information to plural bidders (dealers), and transmits the information to an auction organization which determines a successful bidder in accordance with bid information (sales information) of bidders with respect to the purchase application information. Further, it is preferable that the arrangement is set so that as a reply information, an auction result information, which includes the successful bidder information and the bid information, is received from the auction organization.

Further, in other wards, the information communication method of the present invention is an information communication method for transmitting information of a user device via a network to outside, and for receiving information, transmitted from the outside, and the method makes a computer execute (a) an information generating process for selecting an article suitable for maintenance of the user device so as to generate purchase information which indicates that purchase of the article is required, in accordance with status of the user device, and (b) a communication display process for opening the purchase information to plural dealers, and for receiving sales information, which indicate sales conditions of said article, from respective dealers so as to display the sales information to the user, wherein the communication display process is set to open the purchase information to plural dealers, and to receive sales information of the respective dealers. Further, in the method, the auction server may be set to determine a dealer as a successful bidder in accordance with the sales conditions transmitted from the respective dealers, and the communication display process may be informed of the successful bidder determined by the auction server.

In the communication display process, the sales information etc. is displayed to the user, and the sales information needs to be notified. That is, the communication display process can be expressed as a communication informing process. In the communication informing process, for example, it is possible to inform the sales information to the user by printing out the sales information.

Further, in other wards, the information communication method of the present invention is an information communication method for transmitting information of a user device via a network to outside, and for receiving information transmitted from the outside, which includes: an information generating process for selecting an article suitable for maintenance of the user device, so as to generate purchase information, which indicates that purchase of the article is required, in accordance with status of the user device; and a communication display process for opening the purchase information to plural dealers, and for receiving sales information, which indicate sales conditions of said article, from respective dealers, so as to display the sales information to a user, wherein the communication display process is set to open the purchase information to the plural dealers, and to transmit the purchase information to an auction server which collects the sales information from the respective dealers, and the communication display process is further set to receive the sales information of the respective dealers from the auction server. Further, in the method, the auction server may be set to determine a dealer as a successful bidder in accordance with the sales condition transmitted from the respective dealers, and the communication display process may be set to be informed of the successful bidder determined by the auction server.

Further, in other wards, an information communication apparatus of the present invention, provided in a user device, which is set to be capable of performing communication with outside via a network, includes: an information generating section for selecting an article suitable for maintenance of the user device, so as to generate purchase information which indicates that purchase of the article is required, in accordance with status of the user device; and a communication section for transmitting the purchase information to plural dealers, and for receiving sales information according to sales conditions of the article, from respective dealers, so as to display the sales information to a user.

In the arrangement, the information generating section is set to select an article (maintenance article, peripheral device) which is required (or useful) in accordance with the status of the user device, and to generate the purchase information to purchase the article. Further, the communication section opens the purchase information to the plural dealers, and obtains the sales information from the respective dealers so as to transmit the information to the user. Thus, it is possible to obtain information of an article which is required (useful) in the user device at an appropriate timing, without user's direction. Therefore, it is possible to reduce user's load required in managing the user device. Further, in the arrangement, the communication section transmits the purchase information to the plural dealers, and obtains/displays the sales information based on the sales conditions of the plural dealers. Thus, the user can consider the purchase of an article under a more appropriate condition.

Further, the information communication program of the present invention can be described also as follows. The information communication program of the present invention actuates a computer as an information generating section and as a communication display section, and the computer is installed in an information communication apparatus, provided in a user device, which is set to be capable of performing communication with outside via a network, wherein: the information generating section selects an article suitable for maintenance of the user device, so as to generate purchase information, which indicates that purchase of the article is required, in accordance with status of the user device, and the communication display section opens the purchase information to plural dealers, and receives sales information, which indicate sales conditions of said article, from respective dealers, so as to display the sales information to a user.

Further, the user device, which includes the information communication apparatus of the present invention, can be described also as a device which requires maintenance according to the status on use. Further, the maintenance article can be described as an article which can restore the user device (an article which can make the user device usable). Further, the information communication apparatus of the present invention can be described also as an apparatus which has a function to collect information, used to restore the user device, from the dealers.

Further, the present invention can be described as follows. The present invention relates to a device in which expendables are used and replacement of parts and regular examinations are required. The device judges what service is required automatically in accordance with the status on use, and transmits information concerning the required service to an auction in the network so as to use the auction, so that the device can automatically receive the required service with respect to its expendables. The present invention particularly relates to the device and to a service providing system which realizes the service providing.

Further, in replacement of parts and regular examinations performed in a conventional document service, a user checked how the expendables were worn and considered when the regular examination was to be performed so that the user could ask a service center etc. for the required service, or could have the device examined by the service center at a time of regular visit, or could purchase the expendables.

Further, it can be said that Japanese Unexamined Patent Publication No. 114907/1997 (Tokukaihei 9-114907) discloses a system and a method of a broker auction which is extremely automated in accordance with an electric network in a document service industry. Further, it can be said that Japanese Unexamined Patent Publication No. 340301/1998 (Tokukaihei 10-340301) discloses a device information obtaining apparatus and a method of collecting the device information. In the apparatus and the method, an IC card is applied. The IC card stores not only electrical electric money information but also internal device data and guarantee data of a personal computer and household electrical appliances.

However, in conventional methods as shown in the foregoing publications, a person must perform processes in any step, so that it is impossible to provide an image forming apparatus which is completely automated with respect to the replacement of expendables, an order for the regular examination, and a delivery of an article. For example, in a technique disclosed in Tokukaihei 9-114907, it is possible to obtain the document service by using an automated auction, but a user, who desires the service, performs a process for actual participation in the auction, so that processes are not completely automated. Further, in a technique disclosed in Tokukaihei 10-340301, besides price information at a time when the household electrical appliance is repaired, data which indicates the status of the device and data of the guarantee are stored in the IC card, and the foregoing data are transmitted to a service center by using a telephone line, so that it is possible to perform estimation and settlement, but it is not always possible to obtain the most reasonable article by using the auction in the network. Thus, it is impossible to obtain such effect that the cost can be reduced.

Further, the object of the present invention can be described as follows. The object is to judge automatically what service is required in a device in accordance with the status on use of the device, and to inform the required service to the auction in the network, and to provide a device which can receive service, required for the expendables, by using the auction, and to provide the service providing system.

Further, the following descriptions also can be given. FIG. 1 is an explanatory drawing which shows a series of the procedure performed in the auction (the sales shop (dealer) also performs confirmation in the site). FIG. 2 is a drawing which shows a system concerning the auction, and FIG. 3 is a drawing which shows how the machine information (expendables/maintenance) is informed, and FIG. 10 is a drawing which shows how the machine information (arrangement of the machine) is informed, and FIG. 11 shows processes for making registration with respect to the auction (processes on the side of the user; processes in which a main body obtains the machine information).

Further, an information communication apparatus 13 may inform the auction (auction server 31) of the status concerning the expendables and the maintenance by an E-mail informing function. Further, it also can be said that a process shown in FIG. 4 is a toner level prediction process (procedure in which the information communication apparatus 13 obtains the machine information (information of the digital complex machine 11), and is a procedure in which information such as the expendables (toner etc.) are written (exhibited).

It also can be said that the digital complex machine 11, connected to the network N, which recognizes the status on use of the apparatus includes: the information generating section 41 for detecting required service; the information transmitting section 42 for transmitting information concerning the required service to the auction server 31 in the network N; and the information receiving section 43 for obtaining a result of the auction from the auction server (auction site) 31.

It also can be said that the information generating section 41 recognizes the amount of the left expendables and the regular examination period in accordance with the status on use of the digital complex machine 11 so as to generate information concerning the required service. It also can be said that the information transmitting section 42 transmits the information, generated by the information generating section 41, via the electric network N to the auction server 31 opened in the net. It also can be said that the information receiving section 43 receives information, which concerns a result of the bid performed in the auction site, from the auction server 31, so as to display the information on the digital complex machine 11.

Here, the procedure from generation of the information, which concerns the required service, to decision of a bidder (successful bidder) also can be described as follows by using a series of the procedure of the auction shown in FIG. 1. That is, first, the information concerning the required service is generated by the information generating section 41 provided in the digital complex machine 11, and is transmitted to the auction server 31 by the information transmitting section 42. When the auction server 31 receives information transmitted from the user (exhibitor) of the digital complex machine 11, the auction server 31 displays the information concerning the service required by the user. The information, displayed in the auction server 31, is transmitted to the sales shops 22 to 24 by access from the sales shops 22 to 24, and the desired prices are bid by the sales shops 22 to 24.

In the auction, the contract price is determined by the reverse auction system. The determined contract price is informed to the user as the bid information, and is received by the information receiving section 43, and is displayed on the display section of the digital complex machine 11 or is printed out as information by the printer section. The user can confirm what sales shop bids the article and how much the article was bid in accordance with information informed by the digital complex machine 11. Further, as shown in FIG. 2, the auction server 31 is opened by the managing center 21 organized by a maker, and may be connected to the plural users, the sales shops, and the service center.

Further, in the present system, since the auction server 31 is opened under the control of the managing center 21, it is possible to check whether appropriate expendables are provided or not, and whether appropriate examination service is performed or not. Thus, it is possible to provide service whose quality is stabilized. Further, the managing center 21 holds an auction as a part of service provided by the maker of the digital complex machine 11, so that it is possible to provide service whose quality is stabilized at more reasonable price. Thus, when the digital complex machine 11 is used, it is possible to receive the required service without any operation performed by a person. Further, since the auction is used, the service can be received at the most appropriate price, and the cost can be reduced.

Further, in the left toner confirming process (regular examination time confirming process) shown in FIG. 4 (FIG. 5), the following setting may be performed. When a left toner level is small (when the regular examination period comes), after preparing auction setting information (purchase information), the information generating section 41 performs setting with respect to the auction, that is, transmits information (purchase information) which requests the auction site for the required service. Further, it is preferable that the purchase information is transmitted with a model number which further specifies a model name, an address of the user, and an installation place of the apparatus included. Thus, a sales shop, which provides the service, can provide the required service quickly.

Further, it is preferable that the purchase information is transmitted to the auction site before the expendables and the maintenance article of the apparatus are required. Thus, it is possible to prevent such problems that the apparatus cannot be operated due to the short stock of the expendables, or that the quality of the image, which is recorded after the maintenance period has passed, deteriorates. Thus, the apparatus always can be kept ready to operate.

Further, the sales shops 22 to 24 may be set to confirm whether or not the information, which requests for the service, is transmitted and displayed, in the auction server 31. Further, the information also may be automatically transmitted from the auction server 31 to the sales shops 22 to 24 as soon as the information, which requests for the service, arrives at the auction server 31. Thus, it is possible to receive the service from many sales shops smoothly due to the bid.

Further, as long as an apparatus is used as the information communication apparatus 13 which obtains information of the maintenance article and the peripheral device, the foregoing arrangement may be applied to the apparatus which uses the expendables or requires the maintenance regularly. For example, the arrangement may be applied to an automobile. In this case, the automobile itself recognizes a travel distance so as to generate information which requests for the required service, and transmits the generated information to the auction site in the network N connected to a service center and a sales shop, and further, to a terminal provided in a place, in which the automobile stops, such as a gas station and a car shop.

Here, the information which requests for the required service is information concerning a replacement period of oil and a brake pad, a regular examination period, and a period for the vehicle inspection. Further, data are forwarded by radio, so that transmission and reception of the data, performed between the terminal and the automobile, are completed by stopping at the foregoing places temporarily, or by passing through the places. Further, a sales shop which became a successful bidder in the reverse auction, a service center, a shop, and the like are informed to the user, and the user selects a service arbitrarily from services which satisfy the user's requirement so as to request for the service, so that the user does not have to check the regular examination period for himself/herself, and can receive a reasonable and reliable service. Further, even when the user does not receive the service, the user can confirm when the parts replacement and the regular examination should be performed, so that the foregoing arrangement is superior in terms of the safety, and it is possible to grasp the content of a general service in the market, and the cost (price) etc. While, also on the side of the sales shop, it is possible to obtain new users and to provide a service which can inform many users of the required information such as the period for the regular examination without fail.

Further, the information communication apparatus 13 can be set not to display the information, transmitted in the auction site, by user's setting. Thus, when it is not required that the expendables are added or the regular examination is performed, for example, when the device is to be renewed, it is possible to set the system so that the service is not ordered.

Further, it is preferable that information (machine expansion information) concerning the peripheral devices of the digital complex machine 11, that is, information concerning the status of the devices, which make up the system, such as a post-processing device and a mass storage sheet feeding cassette, is also transmitted (informed) to the auction by an electric mail informing function. Further, the machine information also can be described as a present device information (information concerning the content of the system arrangement).

Further, in the process of FIG. 12, it can be said that, when a change occurs in an arrangement of the device possessed by the user at the present time, plural proposals concerning “what system up should be performed” are transmitted from the auction site to the information communication apparatus 13. At the time, the sales shops and the service center, which are connected to each other via the auction site, may compare information concerning the present device which has already been registered with information in a case of performing the system up, so as to propose a device required in performing the system up. Thus, the information concerning the system up, which are proposed by the sales shops and the service center, are transmitted from the auction site to the device.

Thus, when the user confirms the proposal of the system up and wants to employ the proposal, the user makes contact with the service center which gave the proposal in accordance with the information received by the device, and explains the concrete content of the system up, and consults, and has a business talk. That is, the user of the system can easily obtain information of the device, required in performing the system up, and useful information such as “how to use the system conveniently (usefully)”, merely by watching proposed information. Thus, even though the user does not have sufficient knowledge of the system, the user can grasp what device is required in the system up. Further, also on the side of the service center (sales shop), the foregoing arrangement can be used to obtain new users, and to promote the sales of the peripheral devices, and to communicate with the user effectively.

Further, it is preferable that an organizer of the reverse auction can steadily provide the digital complex machine 11, the maintenance articles, and the peripheral devices (peripheral system devices), that is, the organizer is a maker, a sales maker, and a dealer. Further, it is preferable that many providers gather so as to establish such environment that the service is provided to the user as much as possible. Although there is a case where the service cannot be provided due to the geographical relation (distance) between the user and the dealer, the time and date, and the status of the stocks, it is reliable that other dealers and makers can compensate without fail.

Further, the present invention also can be expressed as the following first to third system devices and the first service providing system. That is, the first system device, connected to a network, includes: information managing means for managing information according to the status of device which makes up the system; information transmitting means for transmitting the information, managed by the information managing means, to the auction site which holds the auction in the network; and information receiving means for receiving provision information provided by the auction site so as to inform the user of the provision information.

According to the arrangement, the device can automatically obtain useful information concerning the system up by adding information concerning peripheral devices of the present device so as to transmit the added information to the auction site. Thus, even though the user does not have sufficient knowledge of the system, it is possible to easily recognize a device, which is required in performing the system up, in accordance with the information transmitted to the device.

Further, the second system device is different from the first system device in that whether or not to open the device information transmitted to the auction is set. According to the arrangement, when there is no need (when a new apparatus is purchased, or the present apparatus is exchanged for new one), the device can be set not to participate in the auction.

Further, the third system device is different from the first system device in that additional information such as a model number, an installation place, and an address of the device which makes up the system, are added to the device information so as to be transmitted to the auction site. According to the arrangement, the additional information of the device (model number, installation place, address, and the like) are added and registered in the auction, so that the model number etc. of the device and the expendables are recognized. Thus, it is possible to receive the required service without fail. Further, it is possible to receive the service, provided by a dealer who became a successful bidder, quickly and without fail.

Further, the first service providing system includes: a process for generating information concerning the system according to the status of the devices which make up the system; a process for transmitting the information to the auction site in the network; and a process for informing the user of a bid result of the auction. In the system, the status of the device which makes up the system is recognized in advance, and is transmitted to the auction site automatically, so that the user can avoid trouble, and can receive the required service at a reasonable price, without fail.

Further, the present invention also can be expressed as a device (expendable device) having the following first to fifth expendables, and the second service providing system. That is, the first expendable device, connected to the network, includes: information managing means for managing information according to the status on use of the device; information transmitting means for transmitting the information, managed by the information managing means, to the auction site which holds the auction in the network; and information receiving means for receiving a bid result, transmitted from the auction site, so as to inform the user of the result.

In the arrangement, the expendable device itself judges the status on use of the expendables and the regular examination etc., and participates in the auction in the network, so that required parts can be obtained. Further, the regular examination periods are not forgotten, and the device is always kept in good condition. Thus, it is not required to check the amount of the left expendables (toner, developer etc.) and the regular examination periods, and it is not required to make contact with a dealer each time any service is required. Thus, it is possible to keep the device always ready to be used without troubling the user. Further, a dealer (sales shop, service center), which provides the most appropriate service at the most appropriate price, is selected from successful bidders, by using the auction in the network, so that it is possible to reduce time and cost required in obtaining the service.

Further, the second expendable device is different from the first expendable device in that the required service is registered in the auction before the device becomes incapable of operating. In the arrangement, the expendable device registers the required parts in the auction before the device becomes incapable of being used, so that the required service can be received before the time limit. Thus, it is possible to keep the device always ready to be used.

Further, the third expendable device is different from the first expendable device or the second expendable device in that the information according to the status on use is information concerning the amount of the left expendables which are used in the device. In the arrangement, a period for replacement can be grasped by recognizing the information concerning the amount of the left expendables, so as to obtain required articles in a required period at a reasonable price, without fail.

Further, the fourth expendable device is different from any one of the first to third expendable devices in that the information according to the status on use is information concerning the regular examination of the device. The exhibition clarifies the service from obtaining parts to the operation charge for parts replacement, so that it is possible to automatically receive the service in which the parts are obtained and replaced. Further, when the dealer becomes a successful bidder in the auction in the network, the dealer, who provides the service, can obtain the order, so that it is possible for the dealer to obtain such advantage that the service can be provided as a reliable service.

Further, the fifth expendable device is different from any one of the first to fourth expendable devices in that additional information such as a model number, an installation place, and an address of the device are added to the information according to the status on use of the device which is transmitted to the auction site. According to the arrangement, the additional information of the device (model number, installation place, address, and the like) are added and registered in the auction, so that the model number etc. of the device and the expendables are recognized. Thus, it is possible to receive the required service more unfailingly. Further, it is possible to receive the service, provided by a dealer who became a successful bidder, quickly and without fail.

Further, the second service providing system includes: a process for generating information concerning parts required according to the status on use of the device (expendable device); a process for transmitting the information to the auction site in the network; and a process for informing the user of a bid result of the auction. In the system, the parts required in the expendable device are recognized in advance, and the recognition is automatically transmitted to the auction site, so that the user can avoid trouble, and can receive the required service at a reasonable price, without fail.

Further, the present invention also can be expressed as the following first to third expendables providing service systems. That is, the first expendables providing service system which includes: a device for automatically setting the purchase of expendables, required in the device, with respect to the auction place; a providing end to which the expendables, required in a device, are provided on a fixed condition; an auction manager for managing dealings performed between the device which requires the expendables and the providing end to which the expendables are provided on a fixed condition, wherein the auction manager is a maker which provides devices.

According to the arrangement, it is possible to manage the circulation of the expendables required in the device, such as the quality level and the circulating amount of the provided expendables, so that it is possible to perform the market quality management and the market providing prediction. Thus, it is possible to provide an environment which can be used dependently by the user who uses the device. Further, since the auction manager is a maker, the auction manager also can provide the expendables, and can provide the expendables required in the device without fail, so that it is possible to avoid such problem that the device cannot be operated due to the shortage of the expendables required in the device. Thus, the user, who possesses the device, can use the device dependently.

Further, the second expendables providing service system which includes: a device for automatically setting the purchase of expendables, required in the device, with respect to the auction place; a providing end to which the expendables, required in a device, are provided on a fixed condition; an auction manager for managing dealings performed between the device which requires the expendables and the providing end to which the expendables are provided on a fixed condition, wherein there is an environment in which the auction manager also can provide the expendables required in the device.

According to the arrangement, it is possible to provide the expendables required in the device without fail, so that it is possible to avoid such problem that the device cannot be operated due to the shortage of the expendables required in the device. Thus, the user, who possesses the device, can use the device dependently.

Further, the third expendables providing system is different from the first expendables providing system or the second expendables providing system in that the auction manager is set to provide the expendables to the device side which requires the expendables, in a case where the dealings performed between the device side, which requires the expendables, and the providing side, which provides the expendables required in the device, is not completed.

As a proposer of the system used as the expendables providing service, the arrangement can provide an environment in which the expendables are provided and received without any trouble. Further, the receiving side of the expendables can obtain the expendables without fail. Further, the providing side of the expendables can participate in the auction to a large extent.

Further, the present invention also can be expressed as the following first to seventh service providing methods (methods of providing service concerning the device). That is, the first service providing method includes the steps of: generating information concerning the status of the device; setting the information, generated by the foregoing step, in the auction; performing a bid concerning an operation to restore the status of the device in accordance with the information opened in the auction; and informing bid information to a manager (owner) of the device. According to the method, it is possible to select a dealer who provides a method of restoring the status of the device, at an appropriate price, and with an appropriate service.

Further, the second service providing method is different from the first service providing method in that the device is an image forming apparatus (apparatus, connected to a network, which operates with expendables), the information concerning the status of the device is information concerning the amount of the left expendables (developer etc.). Thus, it is possible to obtain the expendables at a reasonable price, and without fail. Therefore, the user also obtains much advantage.

Further, the third service providing method is different from the first service providing method in that the device is an image forming apparatus, and the information concerning the status of the device is information concerning a period for the regular examination (parts replacement etc.). Thus, it is possible to perform a bid for a service from obtainment of the parts to the operation charge for the parts replacement, so that the service provider also can provide reliable service, and it is convenient that the user also can receive the service from obtainment of the parts to the operation charge for the parts replacement.

Further, the fourth service providing method is different from the first service providing method in that the device is an image forming apparatus, and the information concerning the status of the device is set in the auction before the apparatus becomes incapable of being operated. Thus, it is possible to compensate the operation of the apparatus, so that it is convenient for the user.

Further, the fifth service providing method is different from the first service providing method in that the device is an image forming apparatus, and the apparatus sets the information concerning the status of the apparatus and additional information of the apparatus (model number, installation place, address etc.) in the auction. Thus, it is possible to provide the expendables exactly in accordance with the model number of the apparatus and the model number of the expendables, and the service provider, which can provide the expendables, can complete the service with respect to the user.

Further, the sixth service providing method is different from the first service providing method in that it is possible to improve the system by combining the device with a peripheral device, and the information concerning the status of the device is information concerning the peripheral device which makes up the present device. Thus, information etc. concerning the system up is provided from the outside, so that even the user, who does not understand the development of the system sufficiently, can easily obtain useful information of the system up etc. Further, it is possible to modify an arrangement of the system partially and to perform a partial addition with respect to the arrangement of the system as required, so that the present system can be improved. Thus, the user also obtain much advantage.

Further, the seventh service providing method is different from the first service providing method in that whether or not to open the information concerning the status of the apparatus in the auction (to participate in the auction), is set in advance. Thus, it is possible to select whether or not to participate in the auction, as required.

The present communication apparatus, provided in a user device, is to perform a communication process with respect to external devices via a network.

Here, the user device means various devices used (managed) by the user, and includes, for example, a personal computer and a copying machine, a printer, an automobile, an elevator, an air conditioner, and the like.

Further, the network is a communication line which connects the present communication apparatus to the external devices, and includes a wide area network such as the Internet and a telephone line which are made up of wired or non-wired lines, a LAN (Local Area Network), a serial cable and an infrared communication line both of which connect apparatuses.

Further, particularly, the present communication apparatus is set so that the information generating section selects an article suitable for maintenance of the user device from various maintenance articles in accordance with the status of the user device.

Further, the information generating section generates purchase information which indicates that purchase of the selected maintenance article is required.

Here, the status of the user device means the user device is in a trouble or not, and means an operating environment, operation log, performance, amount of left expendables, deterioration of replacement parts etc. (how the replacement parts deteriorates).

Note that, the expendables are materials which decrease according to use of the user device, and includes, for example, toner and sheets (recording paper) etc. in a printing apparatus. Further, the replacement parts are parts which are required to be replaced suitably according to use of the user device (parts which are likely to deteriorate), and include, for example, a photosensitive drum, a developer (iron powder; used in a two-component toner), and the like.

Further, the maintenance articles (articles concerning the maintenance of the user device) are materials and service which are required (or useful) in using the user device continuously and in a good condition. The maintenance articles include, for example, expendables used in the user device, replacement parts, repairing service with respect to troubles of the user device, and regular examination service with respect to the user device, and the like.

Further, the purchase information is used to indicate that purchase of the maintenance article is required.

Further, in the present communication apparatus, a communication section, which executes communication with the outside, opens the purchase information to plural dealers. Further, the communication section obtains the purchase information, which indicates a sales condition of the maintenance article, from each of the dealers, and transmits the information to the user.

Here, the dealer is a corporation or a shop (or individual) in which the maintenance article is dealt in (sold). Further, the sales condition of the maintenance article is the content of the service provided by the dealer concerning the article sales, and, for example, is a condition such as the quality, the price, the amount of sales articles, and a delivery period.

In this way, the present communication apparatus is set so that the information generating section selects the maintenance article which is required (or useful) according to the status of the user device, and generates the purchase information to purchase the maintenance article. Further, the communication section opens the purchase information to plural dealers, and obtains the purchase information presented by respective dealers so as to display (transmit) the information to the user.

Thus, in the present communication apparatus, it is possible to obtain information of an article (purchase information) which is required (or useful) for maintenance of the user device at a proper timing, without direction of the user. Therefore, it is possible to remarkably reduce the user's load required in managing the user device.

Further, it is preferable that the information generating section stores information of the maintenance article (name, function, performance, and price etc.) of the user device. Further, it is also preferable that the information generating section (and the communication section) is set to obtain information of the maintenance article (including information of a new product) from the outside (a user device, a maker of the maintenance article) regularly.

Further, in the present communication apparatus, the communication section opens the purchase information to the plural dealers, and obtains and displays the sales information in accordance with the sales conditions of the plural dealers. Thus, the user can select the most suitable condition from the plural sales conditions so as to purchase the maintenance article.

Note that, in the present communication apparatus, the communication section may obtain the sales conditions of the respective dealers, which were arranged (or selected) by the third party.

As the third party, for example, it is possible to use the auction server which transmits (opens) the purchase information to the plural dealers, and collects the sales information from the respective dealers.

In a case where the auction server is used, the communication section transmits the purchase information to the auction server, so as to hold a bid meeting (reverse auction) where dealers, in which the maintenance articles are purchased (dealers who want to sell articles), are collected, and the communication section receives the result (sales information collected from the respective dealers).

Further, the auction server may be set to determine a dealer as a successful bidder in accordance with the sales information transmitted from the respective dealers. In this case, it is preferable that the auction server is set to inform the determined successful bidder (and the bidder's sales information) to the communication section of the present communication apparatus.

Further, in this case, it is preferable that the information generating section makes information, that causes a dealer to be determined as a successful bidder, included in the purchase information. Here, the information, that causes a dealer to be determined as a successful bidder, is information which should be noted in the sales information (quality (types) of the maintenance articles and the peripheral devices (articles), price, date for delivery, and the like).

In this way, according to the information, that causes a dealer to be determined as a successful bidder, the auction server, for example, regards a sales shop which presents the most reasonable price, or a sales shop which presents the earliest date for delivery, as a successful bidder.

In this way, as long as the purchase information is transmitted to the auction server, the purchase information can be transmitted to the plural dealers at once by using the reverse auction. Thus, compared with a case where the purchase information are transmitted to the dealers individually, it is possible to save the trouble of a communication process. Further, it is possible to easily select a dealer whose sales condition is most appropriate.

Further, in the present communication apparatus, it is preferable that the information generating section makes specifying information, which specifies the user device, included in the purchase information.

Here, the specifying information includes, for example, type of the user device (model number), an installation place (address, name of an institution etc.), an address of the user, and the like.

When the present communication apparatus is set in this way, the dealer can judge whether the location of the user device is within his/her sales area or not, or whether he/she deals in a maintenance article which can be applied to the user device. Thus, it becomes easier to generate the sales information, so that the user (the present communication apparatus) can receive the presentation of the sales information quickly and appropriately.

Further, in the present communication apparatus, it is preferable that the information generating section is set to stop generating the purchase information according to the user's instruction. This setting prevents execution of an unnecessary communication process, when a new maintenance article is not required, for example, since the use of the user device is to be stopped in a case where the user device is to be scrapped or resold.

Further, the service providing system of the present invention includes the present communication apparatus and the auction server. Further, it is preferable that the auction server includes: a server communication section for performing communication with an information communication apparatus; an opening section for opening purchase information, transmitted from the information communication apparatus, to plural dealers; a collecting section for collecting sales information from respective dealers; and a server controlling section for transmitting the sales information, that has been collected, via the server communication section to the information communication apparatus.

Further, the server controlling section may be set to determine a dealer as a successful bidder in accordance with the sales information transmitted from the respective dealers, and to inform the determined successful bidder to the communication section of the information communication apparatus.

Thus, it is possible to easily perform the auction and to easily determine a successful bidder by the auction server.

Further, in the system, it is preferable that the server controlling section of the auction server is set to avoid “a dealer, which transmitted sales information indicative of a sales condition which does not satisfy a predetermined standard value, is determined as a successful bidder”. Thus, it is possible to prevent an inappropriate dealer from being a successful bidder.

Note that, the predetermined standard value is a value which the dealer must obey. For example, the standard value is set in accordance with the foregoing information that causes a dealer to be determined as a successful bidder (sales price, date for delivery etc.).

Further, it is preferable that the server controlling section of the auction server is set to inform a specific wholesale shop, which has an article corresponding to the purchase information, of “direction to provide the article to the user of the user device”, in a case where there is no dealer which transmitted the sales information indicative of the sales condition which satisfies the foregoing standard value.

Here, the specific wholesale shop (specific wholesale provider) is a dealer, who is so likely to be capable of providing (storing) the articles, for example, a maker of the user device or the articles, or a sales shop (direct sales shop) managed directly by the wholesale shop. Thus, it is possible to provide desired articles to the user of the user device without fail, so that it is possible to avoid such problem that the device cannot be operated due to the shortage of the expendables etc.

Further, it is preferable that the auction server is managed by the maker of the user device (or the maintenance articles) (it is preferable that the maker organizes the auction). In this case, it is possible to easily give the foregoing direction to the specific wholesale shop.

Further, it is preferable that the opening section of the auction server is set to transmit the purchase information, transmitted from the present communication apparatus, and the sales information, transmitted from the dealer, with respect to the maker of the user device (or the maker of the maintenance articles).

According to the arrangement, the maker can grasp a circulation of the maintenance articles which are required (useful) in the user device. Thus, it is possible to perform the market quality management and the market providing prediction etc., so that it is possible to improve the manufacturing efficiency of the user device (and the maintenance articles) and to improve the using environment of the user device.

Further, it is possible to purchase peripheral devices of the user device by the present communication apparatus.

That is, in other words, an information communication apparatus, provided in a user device, which is set to be capable of performing communication with outside via a network, includes: an information generating section for selecting a peripheral device suitable for maintenance of the user device, so as to generate purchase information which indicates that purchase of the peripheral device is required, in accordance with status of the user device; and a communication section for opening the purchase information to plural dealers, and for receiving sales information, which indicate sales conditions of the article, from respective dealers, so as to display the sales information to a user.

Here, the peripheral device is an optional device, and includes, for example, a stapler etc. of a printing apparatus.

That is, according to the arrangement, the information generating section of the present communication apparatus is set to select a peripheral device suitable for the user device, from various peripheral devices, according to the status of the user device (operating environment, operation log (how the user device is used), performance etc.), so as to generate the purchase information to purchase the device.

Further, as in the case where the maintenance articles are purchased, after the purchase information is opened to the respective dealers, the sales information which include the sales conditions are obtained from the respective dealers.

In this way, when the peripheral device is purchased by using the present communication apparatus, it becomes easier to plan (consider) the system up of the user device.

Note that, also in the case where the peripheral device is purchased, as in the case of the maintenance articles, the reverse auction based on the auction server may be used. Thus, it is possible to open (transmit) the purchase information to the plural dealers easily. Therefore, compared with the case where the purchase information are transmitted to the plural dealers individually, it is possible to save the trouble of a communication process. Further, it is possible to easily select a dealer whose sales condition is most appropriate.

Further, in the case where the sales information of the peripheral device is obtained, it is preferable that the information generating section stores information (name, function, performance, price etc.) of the peripheral device which can be provided in the user device. Further, it is also preferable that the information generating section (and the communication section) is set to obtain information of the peripheral device (including information of a new product) from the outside (user device, maker of the peripheral device) regularly.

Further, the present communication method is a communication method which is used in the present communication apparatus described above. That is, according to the present communication method, in an information generating process, a maintenance article, which is required (or useful), is selected according to the status of the user device, and purchase information for purchasing the maintenance article is generated.

Further, in a communication display process, the purchase information is opened to plural dealers, and sales information presented by the respective dealers are obtained and displayed (transmitted) to the user.

Thus, in the present communication method, it is possible to obtain information of an article which is required (useful) in the user device at an appropriate timing, without user's direction. Therefore, it is possible to reduce user's load remarkably in managing the user device.

Further, also in the present communication method, the reverse auction based on the auction server may be used.

That is, the communication display process of the present communication method may be arranged so that the purchase information is opened to the plural dealers, and the purchase information is transmitted to the auction server, which collects the sales information from the respective dealers, and the sales information of the respective dealers are received from the auction server.

Further, the auction server may be set to determine a dealer as a successful bidder in accordance with the sales conditions transmitted from the respective dealers, and the communication display process may be set to be informed of the successful bidder determined by the auction server.

Thus, it is possible to open (transmit) the purchase information to the plural dealers easily. Therefore, compared with the case where the purchase information are transmitted to the dealers individually, it is possible to save the trouble of a communication process. Further, it is possible to easily select a dealer whose sales condition is most appropriate.

Further, the present communication method also can be described as follows. An information communication program makes a computer execute an information generating process and a communication display process, and the computer is installed in an information communication apparatus, provided in a user device, which is set to be capable of performing communication with outside via a network, wherein: the information generating process selects an article suitable for maintenance of the user device, so as to generate purchase information, which indicates that purchase of the article is required, in accordance with status of the user device, and the communication display process opens the purchase information to plural dealers, and receives sales information, which indicate sales conditions of said article, from respective dealers, so as to display the sales information to a user.

Further, the present communication method also can be described as follows. An information communication method for transmitting information of a user device via a network to outside, and for receiving information, transmitted from the outside, includes: an information generating process for causing an information generating section of an information communication apparatus to select an article suitable for maintenance of the user device, so as to generate purchase information, which indicates that purchase of the article is required, in accordance with status of the user device; and a communication display process for causing a communication section of the information communication apparatus to open the purchase information to plural dealers, and for receiving sales information, which indicate sales conditions of said article, from respective dealers, so as to display the sales information to a user.

Further, the information communication program of the present invention can actuate a computer as the information generating section and the communication section of the present communication apparatus described above, and the computer is installed in a user device, which is set to be capable of performing communication with outside via a network.

Further, the information communication program of the present invention also can be described as an information communication program makes a computer execute the information generating process and the communication display process of the present communication method described above, and the computer is installed in a user device, which is set to be capable of performing communication with outside via a network.

These programs are read by the computer of the information communication apparatus (or the user device) so that it is possible to realize processes of the present communication apparatus (present communication method) by the computer.

Further, by storing these programs in a computer-readable recording medium, it becomes possible to store and circulate the programs easily. Further, the recording medium is read, so that it is possible to open the purchase information and collect the sales information in the present communication apparatus (present communication method), by using the information communication apparatus (or the user device) having the computer.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. An information communication apparatus, provided in a user device, which is set to be capable of performing communication with outside via a network, comprising:
an information generating section for selecting an article suitable for maintenance of the user device, so as to generate purchase information which indicates that purchase of the article is required, in accordance with status of the user device; and
a communication section for opening the purchase information to plural dealers, and for receiving sales information, which indicate sales conditions of said article, from respective dealers, so as to inform the sales information to a user.

2. The information communication apparatus set forth in claim 1, wherein:
said communication section is set to open the purchase information to the plural dealers, and to transmit the purchase information to an auction server which collects the sales information from the respective dealers, and
said communication section is set to receive the sales information of the respective dealers, from the auction server.

3. The information communication apparatus set forth in claim 2, wherein:
said auction server is set to determine a dealer as a successful bidder in accordance with the sales condition transmitted from the respective dealers, and
said auction server is set to inform the communication section of the successful bidder that has been determined.

4. The information communication apparatus set forth in claim 1, wherein said information generating section is set to generate purchase information, which indicates that purchase of an expendable is required in the user device.

5. The information communication apparatus set forth in claim 4, wherein said information generating section is set to generate the purchase information, which indicates that the purchase of the expendable is required in the user device, when an amount of the expendable, left in the user device, becomes less than a predetermined value.

6. The information communication apparatus set forth in claim 1, wherein said information generating section is set to generate purchase information, which indicates that purchase of a replacement part is required in the user device.

7. The information communication apparatus set forth in claim 6, wherein said information generating section is set to generate the purchase information, which indicates that the purchase of the replacement part is required in the user device, when deterioration of the replacement part of the user device becomes more than a predetermined value.

8. The information communication apparatus set forth in claim 1, wherein said information generating section is set to generate purchase information, which indicates that a regular examination is required with respect to the user device.

9. The information communication apparatus set forth in claim 1, wherein said information generating section is set so that the purchase information includes specifying information to specify the user device.

10. The information communication apparatus set forth in claim 1, wherein said information generating section is set to stop generating the purchase information in accordance with an instruction of the user.

11. The information communication apparatus set forth in claim 1, wherein said information generating section is set so that the purchase information includes information that causes a dealer to be determined as a successful bidder.

12. The information communication apparatus set forth in claim 1, wherein said communication section informs the sales information by displaying the sales information.

13. A service providing system comprising an information communication apparatus and an auction server, wherein:
said information communication apparatus, provided in a user device, which is set to perform communication with outside via a network, includes:
an information generating section for selecting an article suitable for maintenance of the user device, so as to generate purchase information which indicates that purchase of the article is required, in accordance with status of the user device; and
a communication section for opening the purchase information to plural dealers, and for receiving sales information, which indicate sales conditions of said article, from respective dealers, so as to inform the sales information to a user, and
the communication section being set to open the purchase information to the plural dealers, and to transmit the purchase information to the auction server which collects the sales information from the respective dealers, and
the communication section further being set to receive the sales information of the respective dealers from the auction server, and
said auction server includes:
a server communication section for performing communication with the information communication apparatus;
an opening section for opening the purchase information, transmitted from the information communication apparatus, to the plural dealers;
a collecting section for collecting the sales information from the respective dealers; and
a server controlling section for transmitting the sales information, that has been collected, via the server communication section to the information communication apparatus.

14. The service providing system set forth in claim 13, wherein:
said server controlling section of said auction server is set to determine a dealer as a successful bidder in accordance with the sales information transmitted from the respective dealers, and
said server controlling section is set to inform the successful bidder to the communication section of the information communication apparatus.

15. The service providing system set forth in claim 14, wherein said server controlling section is set to avoid determining a dealer, who transmits sales information indicative of a sales condition which does not satisfy a predetermined standard value, as the successful bidder.

16. The service providing system set forth in claim 15, wherein said server controlling section is set to inform a specific wholesale shop, which has an article corresponding to the purchase information, of an instruction to provide the article to the user of the user device, in a case where there is no dealer that has transmitted sales information indicative of a sales condition which satisfies said standard value.

17. The service providing system set forth in claim 16, wherein the information generating section of the information communication apparatus is set so that the purchase information includes information that causes the dealer to be determined as the successful bidder, and said standard value is set in accordance with said information that causes the dealer to be determined as the successful bidder.

18. The service providing system set forth in claim 13, wherein said opening section is set to transmit the purchase information, received from the information communication apparatus, and the sales information, received from the dealers, to a maker of the user device.

19. The service providing system set forth in claim 13, wherein said communication section informs the sales information by displaying the sales information.

20. An information communication apparatus, provided in a user device, which is set to be capable of performing communication with outside via a network, comprising:
an information generating section for selecting a peripheral device suitable for the user device, so as to generate purchase information which indicates that purchase of the peripheral device is required, in accordance with status of the user device;
a communication section for opening the purchase information to plural dealers, and for receiving sales information, which indicate sales conditions of said peripheral device, from the respective dealers, so as to inform the sales information to a user.

21. The information communication apparatus set forth in claim 20, wherein:
said communication section is set to open the purchase information to the plural dealers, and to transmit the purchase information to an auction server which collects the sales information from respective dealers, and
said communication section is further set to receive the sales information of the respective dealers.

22. The information communication apparatus set forth in claim 21, wherein:
said auction server is set to determine a dealer as a successful bidder in accordance with the sales information transmitted from the respective dealers, and
said auction server is set to inform the successful bidder, that has been determined, to the communication section.

23. An information communication method for transmitting information of a user device via a network to outside, and for receiving information transmitted from the outside, comprising:
an information generating process for selecting an article suitable for maintenance of the user device, so as to generate purchase information, which indicates that purchase of the article is required, in accordance with status of the user device; and
a communication informing process for opening the purchase information to plural dealers, and for receiving sales information, which indicate sales conditions of said article, from respective dealers, so as to inform the sales information to a user.

24. The information communication method set forth in claim 23, wherein:
said communication informing process is set to open the purchase information to the plural dealers, and to transmit the purchase information to an auction server which collects the sales information from the respective dealers, and
said communication display process is further set to receive the sales information of the respective dealers from the auction server.

25. The information communication method set forth in claim 24, wherein:
said auction server is set to determine a dealer as a successful bidder in accordance with the sales information transmitted from the respective dealers, and
said communication informing process is set to be informed of the successful bidder determined by the auction server.

26. The information communication method set forth in claim 23, wherein said information generating process generates purchase information, which indicates that purchase of an expendable is required in the user device.

27. The information communication method set forth in claim 26, wherein said information generating process generates the purchase information, which indicates that the purchase of the expendable is required, when an amount of the expendable, left in the user device, becomes less than a predetermined value.

28. The information communication method set forth in claim 23, wherein said information generating process generates purchase information, which indicates that purchase of a replacement part is required in the user device.

29. The information communication method set forth in claim 28, wherein said information generating process generates the purchase information, which indicates that the purchase of the replacement part is required, when deterioration of the replacement part of the user device becomes more than a predetermined value.

30. The information communication method set forth in claim 23, wherein said information generating process generates purchase information, which indicates that a regular examination is required with respect to the user device.

31. An information communication method for transmitting information of a user device via a network to outside, and for receiving information, transmitted from the outside, comprising:
an information generating process for selecting an article suitable for maintenance of the user device, so as to generate purchase information which indicates that purchase of the article is required, in accordance with status of the user device; and
a communication informing process for opening the purchase information to plural dealers, and for receiving sales information, which indicate sales conditions of said article, from respective dealers, so as to inform the sales information to a user, wherein
said information generating process and said communication display process are executed by a computer.

32. An information communication method for transmitting information of a user device via a network to outside, and for receiving information, transmitted from the outside, comprising:
an information generating process for causing an information generating section of an information communication apparatus to select an article suitable for maintenance of the user device, so as to generate purchase information, which indicates that purchase of the article is required, in accordance with status of the user device; and
a communication informing process for causing a communication section of the information communication apparatus to open the purchase information to plural dealers, and for receiving sales information, which indicate sales conditions of said article, from respective dealers, so as to inform the sales information to a user.

33. An information communication program which actuates a computer as an information generating section and as a communication section, said computer being installed in an information communication apparatus, provided in a user device, which is set to be capable of performing communication with outside via a network, wherein:
said information generating section selects an article suitable for maintenance of the user device, so as to generate purchase information, which indicates that purchase of the article is required, in accordance with status of the user device, and
said communication section opens the purchase information to plural dealers, and receives sales information, which indicate sales conditions of said article, from respective dealers, so as to inform the sales information to a user.

34. An information communication program which makes a computer execute an information generating process and a communication display process, said computer being installed in an information communication apparatus, provided in a user device, which is set to be capable of performing communication with outside via a network, wherein:
said information generating process selects an article suitable for maintenance of the user device, so as to generate purchase information, which indicates that purchase of the article is required, in accordance with status of the user device, and
said communication informing process opens the purchase information to plural dealers, and receives sales information, which indicate sales conditions of said article, from respective dealers, so as to inform the sales information to a user.

35. A computer-readable recording medium which stores an information communication program which actuates a computer as an information generating section and as a communication display section, said computer being installed in an information communication apparatus, provided in a user device, which is set to be capable of performing communication with outside via a network, wherein:
said information generating section selects an article suitable for maintenance of the user device, so as to generate purchase information, which indicates that purchase of the article is required, in accordance with status of the user device, and
said communication section opens the purchase information to plural dealers, and receives sales information, which indicate sales conditions of said article, from respective dealers, so as to inform the sales information to a user.

36. A computer-readable recording medium which stores an information communication program, which makes a computer execute an information communication method which includes an information generating process and a communication display process, said computer being installed in an information communication apparatus, provided in a user device, which is set to be capable of performing communication with outside via a network, wherein:
said information generating process selects an article suitable for maintenance of the user device, so as to generate purchase information, which indicates that purchase of the article is required, in accordance with status of the user device, and
said communication informing process opens the purchase information to plural dealers, and receives sales information, which indicate sales conditions of said article, from respective dealers, so as to inform the sales information to a user.

37. An information communication apparatus, provided in a user device, which is set to be capable of performing communication with outside, comprising:
an information generating section for generating device information concerning the user device;
a communication section for transmitting the device information to plural sending ends, and for receiving reply information with respect to the device information; and
a display section for displaying the reply information.

38. The information communication apparatus set forth in claim 36, wherein:
said information generating section generates purchase application information, which indicates that purchase of an article concerning the user device is required, as the device information, and
said communication section is set to open the purchase application information to plural dealers, and to transmit the purchase application information to an auction organization that determines a successful bidder in accordance with sales information transmitted by bidders with respect to the purchase application information, and said communication section is further set to receive auction result information which includes successful bidder information and bid information, as reply information, from the auction organization.

39. An information communication method for transmitting information of a user device via a network to outside, and for receiving information, transmitted from the outside, said method making a computer execute (a) an information generating process for selecting an article suitable for maintenance of the user device so as to generate purchase information which indicates that purchase of the article is required, in accordance with status of the user device, and (b) a communication display process for opening the purchase information to plural dealers, and for receiving sales information, which indicate sales conditions of said article, from respective dealers so as to display the sales information to the user, wherein said communication display process is set to open the purchase information to the plural dealers, and to transmit the purchase information to an auction server which collects the sales information from the respective dealers, and said communication display process is further set to receive the sales information of the respective dealers from the auction server.

40. The information communication method set forth in claim 39, wherein said auction server is set to determine a dealer as a successful bidder in accordance with the sales conditions transmitted from the respective dealers, and said communication display process is set to be informed of the successful bidder determined by the auction server.

41. An information communication method for transmitting information of a user device via a network to outside, and for receiving information, transmitted from the outside, comprising:
an information generating process for causing an information generating section of an information communication apparatus to select an article suitable for maintenance of the user device, so as to generate purchase information, which indicates that purchase of the article is required, in accordance with status of the user device; and
a communication display process for causing a communication section of the information communication apparatus to open the purchase information to plural dealers, and for receiving sales information, which indicate sales conditions of said article, from respective dealers, so as to display the sales information to a user, wherein:
said communication display process is further set to open the purchase information to plural dealers, and to transmit the purchase information to an auction server, which collects the sales information from the respective dealers, and
said communication display process is further set to receive the sales information of the respective dealers from the auction server.

42. The information communication method set forth in claim 41, wherein said auction server is set to determine a dealer as a successful bidder in accordance with the sales conditions transmitted from the respective dealers, and said communication display process is set to be informed of the successful bidder determined by the auction server.

43. An information communication apparatus, provided in a user device, which is set to be capable of performing communication with outside, comprising:
an information generating section for selecting an article suitable for the user device, so as to generate purchase information, which indicates that purchase of the article is required, in accordance with status of the user device; and
a communication section for transmitting the purchase information to plural dealers, and for receiving sales information according to sales conditions of said article from respective dealers, so as to display the sales information to a user.
